(19) United States
(12) Patent Application Publication
(10) Pub. No.: US 2014/0240955 A1
(43) Pub. Date: Aug. 28, 2014

(54) Luminaire

(71) Applicant: Toshiba Lighting & Technology Corporation, Yokosuka-shi (JP)

(72) Inventors: Hikaru Terasaki, Yokosuka-shi (JP); Takeshi Hisayasu, Yokosuka-shi (JP); Yusuke Shibahara, Yokosuka-shi (JP); Katsuyuki Kobayashi, Yokosuka-shi (JP)

(73) Assignee: TOSHIBA LIGHTING & TECHNOLOGY CORPORATION, Yokosuka-shi (JP)

(21) Appl. No.: 14/026,071

(22) Filed: Sep. 13, 2013

(30) Foreign Application Priority Data
Feb. 26, 2013 (JP) 2013-036467

(51) Int. Cl. F21V 13/14; F21V 29/00

(52) U.S. Cl. CPC F21V 13/14; F21V 29/22
USPC 362/84; 362/296.01; 362/296.05; 362/308

(57) ABSTRACT

According to one embodiment, a luminaire includes a main body section including a flat surface on one end side, a light-emitting module provided to be thermally joined to the flat surface and including a light-emitting element that emits light having a peak wavelength equal to or larger than 430 nm and equal to or smaller than 500 nm, a reflecting section provided on one end side of the main body section and configured to reflect the light emitted from the light-emitting element, a heat transfer section provided such that one end side thereof projects to the one end side of the main body section, the other end side of which being connected to the main body section, and a wavelength converting section provided spaced apart from the light-emitting element to cover the light-emitting module and to be thermally joined to the main body section and the heat transfer section.

### CROSS-REFERENCE TO RELATED APPLICATIONS

This application is based upon and claims the benefit of priority from Japanese Patent Application No. 2013-036467, filed on Feb. 26, 2013; the entire contents of which are incorporated herein by reference.

### FIELD

Embodiments described herein relate generally to a luminaire.

### BACKGROUND

In recent years, a luminaire including a light-emitting diode (LED) as a light source has been put to practical use instead of an incandescent lamp (a filament bulb).

The luminaire including the light-emitting diode has a long life. Power consumption of the luminaire can be reduced. Therefore, it is expected that the luminaire replaces the existing incandescent lamp.

In the luminaire including the light-emitting diode, further improvement of light emission efficiency is desired.

### DESCRIPTION OF THE DRAWINGS

FIG. 1 is a schematic perspective view for illustrating a luminaire according to an embodiment;

FIG. 2 is a schematic diagram for illustrating a relation between dimensions of a reflecting section and dimensions of an end portion of a main body section;

FIGS. 3A and 3B are schematic diagrams for illustrating a relation between the shape of a wavelength converting section and a luminous intensity distribution angle, wherein FIG. 3A is a schematic diagram for illustrating the relation in the case in which the shape of the wavelength converting section is a semispherical shape and FIG. 3B is a schematic diagram for illustrating the relation in the case in which the shape of the wavelength converting section is close to a full spherical shape;

FIGS. 4A to 4D are schematic partially enlarged views for illustrating a step section provided in a step of a heat transfer section;

FIG. 5 is a graph for illustrating the reflectance of a reflecting layer;

FIGS. 6A and 6B are schematic perspective views for illustrating a tabular body included in a heat transfer section, wherein FIG. 6A is a schematic perspective view for illustrating a tabular unit in which two tabular bodies are integrally formed and FIG. 6B is a schematic perspective view for illustrating a tabular body;

FIG. 7 is a schematic plan view for illustrating connection by a groove section and a protrusion section for connection;

FIGS. 8A and 8B are schematic diagrams for illustrating an opening section provided in the heat transfer section, wherein FIG. 8A is a schematic diagram for illustrating the opening section provided in the heat transfer section and FIG. 8B is a schematic graph for illustrating an effect of the provision of the opening section;

FIG. 9 is a schematic partial sectional view for illustrating an opening section according to another embodiment;

FIG. 10 is a schematic graph for illustrating the thickness dimension of the tabular body;

FIGS. 11A to 11D are schematic diagrams for illustrating a connecting portion of the heat transfer section and a substrate, wherein FIGS. 11A and 11C are schematic diagrams in which a decrease in thermal resistance is not taken into account and FIGS. 11B and 11D are schematic diagrams in which a reduction in thermal resistance is attempted;

FIGS. 12A and 12B are schematic diagrams for illustrating a protrusion section provided on the surface of the heat transfer section, wherein FIG. 12A is a schematic diagram for illustrating one protrusion section provided on the surface of the heat transfer section and FIG. 12B is a schematic diagram for illustrating a plurality of protrusion sections provided on the surface of the heat transfer section;

FIGS. 13A and 13B are schematic diagrams for illustrating an arrangement of the heat transfer section and a light-emitting element in plan view, wherein FIG. 13A is a schematic diagram for illustrating the arrangement of the heat transfer section and the light-emitting element in plan view and FIG. 13B is a schematic diagram for illustrating a positional relation between the heat transfer section and the light-emitting element in plan view;

FIG. 14 is a schematic perspective view for illustrating a wavelength converting section divided for each of regions partitioned by the heat transfer section;

FIGS. 15A and 15B are schematic perspective views for illustrating a blocking section, wherein FIG. 15A is a schematic perspective view for illustrating the blocking section and FIG. 15B is a schematic perspective view for illustrating the top of the heat transfer section;

FIGS. 16A and 16B are schematic diagrams for illustrating a state of thermal radiation in a luminaire in which the heat transfer section is not provided, wherein FIG. 16A is a schematic diagram for illustrating a temperature distribution of the luminaire and FIG. 16B is a schematic diagram for illustrating a temperature distribution near the end portion of the main body section;

FIGS. 17A and 17B are schematic diagrams for illustrating a state of thermal radiation in a luminaire in which the heat transfer section is provided, wherein FIG. 17A is a schematic diagram for illustrating the state of thermal radiation in the case in which the inner surface of the wavelength converting section and the end face of the heat transfer section are in contact with each other and FIG. 17B is a schematic diagram for illustrating the state of thermal radiation in the case in which the end face of the heat transfer section is exposed from the wavelength converting section;

FIG. 18 is a schematic perspective view for illustrating a reflecting section according to another embodiment;

FIG. 19 is a schematic sectional view for illustrating a luminaire according to another embodiment;

FIG. 20 is a schematic sectional view for illustrating a luminaire according to another embodiment; and

FIG. 21 is a schematic diagram for illustrating action and effects of a lens.

### DETAILED DESCRIPTION

In general, according to one embodiment, there is provided a luminaire including: a main body section including a flat surface on one end side; a light-emitting module provided to be thermally joined to the flat surface of the main body section and including a light-emitting element that emits light having a peak wavelength equal to or larger than 430 nm and equal to or smaller than 500 nm; a reflecting section provided on one end side of the main body section and configured to reflect the light emitted from the light-emitting element; a heat transfer section provided such that one end side thereof projects to the one end side of the main body section, the other end side of which being connected to the main body section; and a wavelength converting section provided spaced apart from the light-emitting element to cover the light-emitting module and to be thermally joined to the main body section and the heat transfer section.

With the luminaire, it is possible to improve thermal radiation properties and reflect the light having the peak wavelength equal to or larger than 430 nm and equal to or smaller than 500 nm emitted from the light-emitting element while suppressing the light from being absorbed in the main body section. Therefore, it is possible to improve light emission efficiency.

In the luminaire, it is preferable that the flat surface is provided to be orthogonal to the center axis of the luminaire, the reflecting section is a tabular body including at least one opening and is provided on the flat surface to expose the light-emitting element from the opening to the one end side of the main body section.

With the luminaire, it is possible to efficiently emit and reflect the light of the light-emitting element. Therefore, it is possible to improve the light emission efficiency with a simple structure.

In the luminaire, it is preferable that the reflecting section is arranged on the flat surface and includes an inclined surface at an outer end portion, the inclined surface facing one end side.

With the luminaire, it is possible to reflect the light having the peak wavelength equal to or larger than 430 nm and equal to or smaller than 500 nm while suppressing the light from being absorbed in the main body section and supply the light to the other end side of the wavelength converting section. Therefore, it is possible to expand a luminous intensity distribution while improving the light emission efficiency.

In the luminaire, it is preferable that, when a dimension from the position of the center axis of the luminaire to an outer end portion on the one end side of the main body section is represented as R, a dimension from the flat surface of the main body section to the top of the luminaire is represented as L, a dimension from the position of the center axis of the luminaire to an outer end portion of the reflecting section is represented as r, and a dimension from the reflecting section to the top of the luminaire is represented as I, the following expression is satisfied:

r>R·I/L

With the luminaire, it is possible to reflect the light emitted from the light-emitting element while suppressing the light from being absorbed in the main body section. Therefore, it is possible to improve the light emission efficiency.

In the luminaire, it is preferable that, when a dimension from the position of the center axis of the luminaire to an outer end portion on the one end side of the main body section is represented as R, a dimension from the flat surface of the main body section to the top of the luminaire is represented as L, a dimension from the position of the center axis of the luminaire to an outer end portion of the reflecting section is represented as r, and a dimension from the reflecting section to the top of the luminaire is represented as I, the following expression is satisfied:

r≦R·I/L

With the luminaire, it is possible to supply the light emitted from the light-emitting element to the other end side of the wavelength converting section. Therefore, it is possible to expand a luminous intensity distribution.

In the luminaire, it is preferable that the wavelength converting section includes, between the reflecting section and the top of the luminaire, a largest diameter section where a dimension from the position of the center axis of the luminaire to the inner surface of the wavelength converting section is larger than the dimension R, and the dimension of a portion located on the outer end side of the reflecting section from the position of the center axis of the luminaire to the inner surface of the portion is larger than the dimension R and smaller than the largest diameter section.

With the luminaire, it is possible to expand a luminous intensity distribution while improving the light emission efficiency.

In the luminaire, it is preferable that the wavelength converting section is connected to a surface on the outer end side of the heat transfer section such that at least a part of the heat transfer section is in contact with the outside air.

With the luminaire, since heat transferred from the wavelength converting section is radiated, it is possible to suppress the heat from being transferred to the main body section side by radiating the heat. Therefore, it is possible to improve the light emission efficiency.

In the luminaire, it is preferable that the heat transfer section includes: a first tabular body provided such that the other end side is connected to an outer end portion of the main body section and the one end side projects toward the top of the luminaire; and a second tabular body, the other end side of which is connected to the outer end portion of the main body section in a position different from the first tabular body and the one end side of which projects to the one end side of the main body section toward the top of the luminaire, the second tabular body being connected to the first tabular body near the top, the wavelength converting section includes a first wavelength converting section and a second wavelength converting section, the first wavelength converting section is provided in a first region partitioned by the first tabular body and the second tabular body, and the second wavelength converting section is provided in a second region partitioned by the first tabular body and the second tabular body.

With the luminaire, since the wavelength converting section is configured by being divided into a plurality of wavelength converting sections, it is possible to facilitate attachment to the heat transfer section while improving thermal radiation properties.

In the luminaire, it is preferable that the end face of the heat transfer section is exposed from the wavelength converting section.

With the luminaire, it is possible to improve thermal radiation properties.

In the luminaire, it is preferable that the wavelength converting section includes a phosphor.

With the luminaire, it is possible to change a color and a in of light irradiated from the luminaire simply by replacing the wavelength converting section.

In the luminaire, it is preferable that the light-emitting module is held by the main body section and the reflecting section.

With the luminaire, it is possible to improve thermal radiation properties.

In the luminaire, it is preferable that, when an angle formed by the inclined surface of the reflecting section and an axis extending along the center axis of the luminaire is represented as α and an angle formed by an outer end portion on the one end side of the main body section and the axis extending along the center axis of the luminaire is represented as β, the following expression is satisfied:

α≧β

With the luminaire, it is possible to reduce blue light absorbed by the main body section as much as possible and realize a highly efficient luminaire.

In the luminaire, it is preferable that a surface on one end side of the light-emitting element projects from a surface on one end side of the reflecting section in the direction of the top of the luminaire.

With the luminaire, it is possible to prevent light irradiated from the light-emitting element from being blocked by the reflecting section.

In the luminaire, it is preferable that the heat transfer section has reflectance higher than the reflectance of the wavelength converting section.

With the luminaire, it is possible to reduce variance in brightness.

In the luminaire, it is preferable that the heat transfer section assumes a tabular shape and includes an opening section that pierces through the heat transfer section in the thickness direction.

With the luminaire, it is possible to suppress light irradiated from the light-emitting element from being blocked by the heat transfer section.

In the luminaire, it is preferable that the thickness dimension of the heat transfer section is equal to or larger than 0.5 mm and equal to or smaller than 5 mm.

With the luminaire, it is possible to improve light extracting efficiency to be equal to or higher than 90%.

In the luminaire, it is preferable that a plurality of the light-emitting elements are provided, and the plurality of light-emitting elements are arranged on the circumference of a circle centering on the position of the center axis of the luminaire.

With the luminaire, it is possible to expand a luminous intensity distribution angle.

In the luminaire, it is preferable that the luminaire further includes a globe configured to cover the wavelength converting section.

With the luminaire, it is possible to reduce the wavelength converting section in size and reduce an amount of use of a phosphor. A conventional globe can be used as the globe. Therefore, it is possible to reduce costs.

In the luminaire, it is preferable that the luminaire further includes a lens including a first concave section opened on the light-emitting element side and a second concave section opened on a side opposite to the light-emitting element side, the lens being provided between the light-emitting module and the wavelength converting section.

With the luminaire, it is possible to expand a luminous intensity distribution angle.

Embodiments are explained below with reference to the drawings. In the drawings, the same components are denoted by the same reference numerals and signs and detailed explanation of the components is omitted as appropriate.

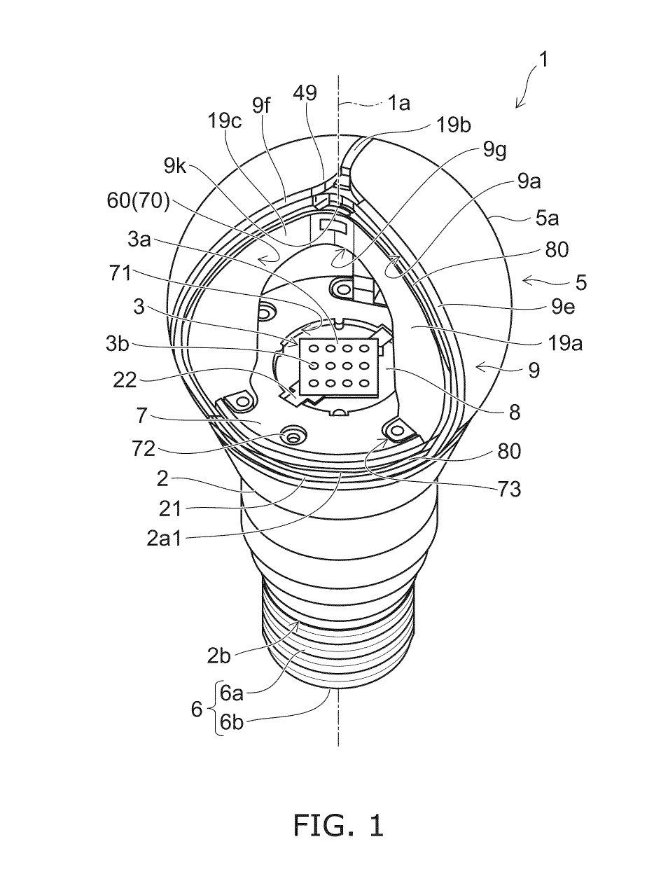

FIG. 1 is a schematic perspective view for illustrating a luminaire according to an embodiment.

As shown in FIG. 1, a luminaire 1 includes a main body section 2, a light-emitting module 4, a wavelength converting section 5, a cap section 6, a reflecting section 7, a substrate 8, and a heat transfer section 9. In this embodiment, for convenience of explanation, a direction in which the wavelength converting section 5 is located with respect to the main body section 2 is referred to as one end side, a direction in which the cap section 6 is located is referred to as the other end side, and a direction perpendicular to a center axis 1a of the luminaire 1 and extending to the outer side is referred to as outer end side.

The main body section 2 includes a flat surface 21 on one end side. The flat surface 21 can be provided such that a surface on one end side thereof is orthogonal to the center axis 1a of the luminaire 1. A projection 22 projecting to one end side of the luminaire 1 can be formed on the one end side of the main body section 2.

The main body section 2 can be formed in, for example, a shape, a cross sectional area of which in a direction perpendicular to the axis direction gradually increases from the cap section 6 side toward the wavelength converting section 5 side. A thermal radiation fin can be provided on a side surface of the main body section 2. However, the main body section 2 is not limited to this. The main body section 2 can be changed as appropriate according to, for example, the sizes of a light source 3, the wavelength converting section 5, and the like and the size of the cap section 6. In this case, if the main body section 2 is approximated to the shape of a neck portion of an incandescent lamp, it is possible to easily replace the existing incandescent lamp with the luminaire 1.

The main body section 2 can be formed of, for example, a material having high heat conductivity. The main body section 2 can be formed of metal such as aluminum (Al), copper (Cu), or an alloy of aluminum and copper. However, the material of the main body section 2 is not limited to these materials. The main body section 2 can also be formed of an inorganic material such as aluminum nitride (AlN) or alumina (Al₂O₂), an organic material such as high-heat conductivity resin, or the like.

The light-emitting module 4 includes the substrate 8 and the light source 3 mounted on a surface on one end side of the substrate 8. A surface on the other end side of the substrate 8 is connected to the flat surface 21 of the main body section 2. When the projection 22 is formed in the main body section 2, the light-emitting module 4 is connected to the flat surface 21 on one end side of the projection 22.

Light-emitting elements 3b are provided in the light source 3. The number of the light-emitting elements 3b provided in the light source 3 is not specifically limited. One or more light-emitting elements 3b only have to be provided according to a use of the luminaire 1, the size of the light-emitting elements 3b, and the like.

The light-emitting elements 3b can be, for example, light-emitting diodes that emit blue light (blue light-emitting diodes). The blue light is light having a peak wavelength equal to or larger than 430 nm and equal to or smaller than 500 nm.

When a plurality of the light-emitting elements 3b are provided in the light source 3, a regular arrangement form such as a matrix shape, a zigzag shape, or a radial shape can be adopted or an arbitrary arrangement form can be adopted.

When the plurality of light-emitting elements 3b are provided in the light source 3, light-emitting diodes that emit lights of other colors may be mixed other than the light-emitting diodes that emit the blue light. For example, light-emitting diodes that emit red light (red light-emitting diodes) may be mixed other than the light-emitting diodes that emit the blue light. Consequently, it is possible to improve color rendering properties. The light source 3 can also be a light source of a so-called COB (Chip On Board) type in which a plurality of the light-emitting elements 3b that emit the blue light are mounted on the substrate 8 and sealed by transparent resin or the like.

The wavelength converting section 5 is provided on an end portion 2a side of the main body section 2 to cover the light source 3. That is, the wavelength converting section 5 is provided at the end portion 2a of the main body section 2 to be spaced apart from the light-emitting elements 3b. The wavelength converting section 5 can be a section including a curved surface projecting in an irradiating direction of light.

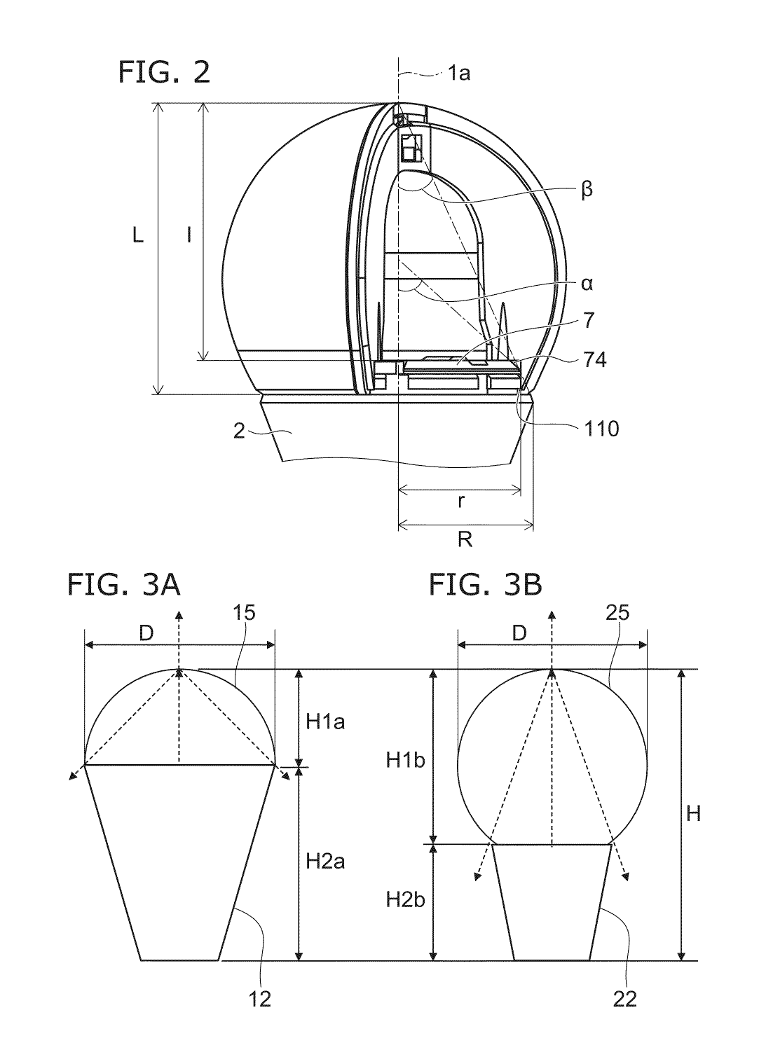

The wavelength converting section 5 functions as a globe as well. It is preferable that the wavelength converting section 5 is formed in a shape including, between the reflecting section 7 and the top of the luminaire 1, in particular, near the middle between the reflecting section 7 and the top of the luminaire 1, a largest diameter section, the dimension of which from the position of the center axis 1a of the luminaire 1 to the inner surface of the wavelength converting section 5 is larger than a dimension R and including a portion located on an outer end side of the reflecting section 7, the dimension of which from the position of the center axis 1a of the luminaire 1 to the inner surface of the portion is larger than the dimension R and smaller than the largest diameter section. The dimension R is a dimension from the position of the center axis 1a of the luminaire 1 to an outer end portion on the one end side of the main body section 2 (see FIG. 2).

The wavelength converting section 5 is provided to be divided for each of regions partitioned by the heat transfer section 9. An end face 9e of the heat transfer section 9 is exposed from the wavelength converting section 5, that is, is in contact with the outside air.

Consequently, it is possible to easily assemble the luminaire 1 having high thermal radiation properties.

The wavelength converting section 5 has translucency and allows lights irradiated from the light-emitting elements 3b to be emitted to the outside of the luminaire 1. The wavelength converting section 5 can be formed of a translucent material. The wavelength converting section 5 can be formed of, for example, a resin material such as polycarbonate. The wavelength converting section 5 can also be formed of a material excellent in light diffusion properties.

The wavelength converting section 5 absorbs a part of the lights irradiated from the light-emitting elements 3b and emits fluorescence having a predetermined wavelength. The wavelength converting section 5 can be, for example, a section containing a phosphor on the inside (the phosphor is kneaded in a translucent material) or a section applied with the phosphor on the inner surface.

For example, the phosphor can be a phosphor that absorbs a part of blue light irradiated from the light-emitting elements 3b and emits yellow fluorescence. Examples of the phosphor include a YAG (Yttrium Aluminum Garnet) phosphor. In this case, the blue light not absorbed by the phosphor and the yellow light emitted from the phosphor are mixed to be white light.

The phosphor is not limited to the YAG phosphor. The phosphor can be changed as appropriate according to, for example, a use of the luminaire 1. For example, by selecting a type of the phosphor, light having a color temperature equal to or higher than 2800 K and equal to or lower than 3000 K (a bulb color) can be irradiated from the luminaire 1.

In this case, simply by replacing the wavelength converting section 5, it is possible to change a color and a in of the light irradiated from the luminaire 1.

When a part of the lights irradiated from the light-emitting elements 3b is absorbed by the phosphor, a part of the energy of the absorbed light changes to heat. Therefore, if the wavelength converting unit including the phosphor is provided in close contact with the light-emitting elements 3b as in a white LED in which general light-emitting elements that emit blue light and a phosphor that emits yellow light are combined and packaged by resin, it is likely that not only heat generated by the light-emitting elements 3b but also heat generated by the phosphor is added and the temperature of the light-emitting elements 3b rises. As a result, electric power input to the light-emitting elements 3b cannot be increased and improvement of light emission efficiency cannot be attained.

In this embodiment, the wavelength converting section 5 provided at the end portion 2a of the main body section 2 to be spaced apart from the light-emitting elements 3b. The outer surface of the wavelength converting section 5 functioning as a heat generation source is a thermal radiation surface. The heat of the wavelength converting section 5 can be transferred to the main body section 2 by the heat transfer section 9. Therefore, the heat generated in the wavelength converting section 5 is less easily transferred to the light-emitting elements 3b. The heat can be efficiently emitted. Therefore, it is possible to increase electric power input to the light-emitting elements 3b. As a result, it is possible to attain improvement of the light emission efficiency.

The cap section 6 is provided at an end portion 2b on the opposite side of the side of the main body section 2 where the wavelength converting section 5 is provided. The cap section 6 can be a section having a shape attachable to a socket to which an incandescent lamp is attached. The cap section 6 can be, for example, a section having a shape same as the E26 type, the E17 type, or the like specified in the JIS standard. However, the cap section 6 is not limited to the shape and can be changed as appropriate. For example, the cap section 6 can be a section including a pin type terminal used in a fluorescent lamp or can be a section including an L-shaped terminal used in a hanging ceiling.

The cap section 6 shown in FIG. 1 includes a cylindrical shell section 6a having thread ridges and an eyelet section 6b provided at an end portion on a side of the shell section 6a opposite to the main body section 2 side. A not-shown control section is electrically connected to the shell section 6a and the eyelet section 6b.

The not-shown control section is provided on the inside of the main body section 2. The control section can include a lighting circuit configured to supply electric power to the light-emitting elements 3b. The control section can also include a dimming circuit for performing dimming of the light-emitting elements 3b.

The reflecting section 7 can be a tabular body having an annular shape.

The reflecting section 7 is provided at the end portion 2a of the main body section 2 and directly or indirectly reflects the lights irradiated from the light-emitting elements 3b. In this embodiment, the reflecting section 7 includes an opening 71 in the center, includes, near the outer end, a screw hole 72 and housing holes 73 in which a part of the heat transfer section 9, in particular, attaching sections 19a1, 19b1, and 19c1 explained below are housed, and includes a recess (not shown in the figure) on the other end side near the opening 71. A screw is inserted into the screw hole 72 from one end side of the reflecting section 7 and screwed into a screw hole (not shown in the figure) on the one end side of the main body section 2, whereby the reflecting section 7 is fixed to the main body section 2. When the reflecting section 7 is fixed to the main body section 2, the substrate 8 is fixed to the flat surface 21 by the recess of the reflecting section 7. That is, the light-emitting module 4 is held by the main body section 2 and the reflecting section 7. The reflecting section 7 includes an inclined surface 74 at the outer end portion. One end side of the inclined surface 74 is inclined in a direction approaching the center axis 1a of the luminaire 1. The reflecting section 7 is arranged above the flat surface 21 such that the inclined surface 74 faces the one end side. An angle α of an inclined portion partitioned by the inclined surface 74 and an axis extending along the center axis 1a is preferably equal to or larger than an angle β formed by the axis extending along the center axis 1a, the top of the luminaire 1, and the outer end portion on the one end side of the main body section 2 (see FIG. 2).

The annular reflecting section 7 is provided to surround the light source 3. That is, the light source 3 is arranged in the opening 71 formed in the center of the reflecting section 7 and the light-emitting elements 3b are exposed from the reflecting section 7. In order to reduce the influence due to shading, surfaces on one end side of the light-emitting elements 3b desirably project from a surface on the one end side of the reflecting section 7 in the direction of the top of the luminaire 1.

The reflecting section 7 is formed of a material having high reflectance (in particular, reflectance to light having a peak wavelength equal to or larger than 430 nm and equal to or smaller than 500 nm). Examples of the material having high reflectance include a white resin material. The material having high reflectance is preferably a material having high resistance to heat generated in the light source 3. Therefore, the material having high reflectance is preferably, for example, white polycarbonate resin.

FIG. 2 is a schematic diagram for illustrating a relation between the dimension of the reflecting section 7 and the dimension of the end portion 2a of the main body section 2.

In FIG. 2, a dimension from the position of the center axis 1a of the luminaire 1 to the peripheral end of the end portion 2a is represented as R and a dimension from the end portion 2a to the top of the luminaire 1 is represented as L. A dimension from the position of the center axis 1a of the luminaire 1 to the peripheral end of the reflecting section 7 is represented as r and a dimension from the upper surface (a reflecting surface) of the reflecting section 7 to the top of the luminaire 1 is represented as 1.

According to the knowledge obtained by the inventors, it is found that it is possible to realize a luminaire having desired characteristics according to relative dimensions of the main body section 2 and the reflecting section 7.

When a dimension from the position of the center axis la of the luminaire 1 to the outer end portion on the one end side of the main body section 2 is represented as R, a dimension from the flat surface 21 of the main body section 2 to the top of the luminaire 1 is represented as L, a dimension from the position of the center axis 1a of the luminaire 1 to the outer end portion of the reflecting section 7 is represented as r, and a dimension from the reflecting section 7 to the top of the luminaire 1 is represented as I, the following expression is satisfied:

r>R·I/L

Consequently, it is possible to, in particular, reduce the blue light absorbed by the main body section 2 as much as possible and realize a highly efficient luminaire.

In this case, in particular, the dimension r is preferably a dimension equal to or larger than the dimension R and enough for forming a slight gap between the reflecting section 7 and the inner surface of the wavelength converting section 5.

On the other hand, when the following expression is satisfied:

r≦R·I/L

it is possible to guide light to the other end side of the wavelength converting section 5 and realize a luminaire having wide luminous intensity distribution.

That is, it is preferable to adjust the dimensions of the reflecting section 7 and the like as explained above according to desired characteristics. In both the cases, the reflecting section 7 preferably includes the inclined surface 74 at the end edge thereof. This is because, if the reflecting section 7 includes the inclined surface 74, it is possible to effectively block the blue light to the main body section 2 and guide the blue light to the other end side of the wavelength converting section 5. When the reflecting section 7 includes the inclined surface 74, the dimension r is a dimension from the position of the center axis la of the luminaire 1 to the outer end portion on the other end side of the reflecting section 7 and the dimension I is a dimension from the other end side of the reflecting section 7 to the top of the luminaire 1.

The substrate 8 is provided at the end portion 2a of the main body section 2.

The substrate 8 can be formed of, for example, a material having high heat conductivity. The substrate 8 can be formed of metal such as aluminum (Al), copper (Cu), iron (Fe), or alloys of aluminum, copper, and iron. A not-shown wiring pattern can be formed on the surface of the substrate 8 via an insulating layer. The material of the substrate 8 is not limited to these materials and can be changed as appropriate. For example, the substrate 8 can be a substrate in which a wiring pattern is formed on the surface of a base material formed using resin. In the substrate 8, a base material formed of a ceramics material such as aluminum oxide (Al₂O₂) or aluminum nitride (AlN) or an organic material such as high-heat conductivity resin can be used. If the substrate 8 is formed of the material having high heat conductivity, it is easy to radiate heat generated in the light source 3 to the outside via the substrate 8 and the main body section 2. Further, as explained below, it is easy to radiate the heat generated in the light source 3 to the outside via the substrate 8, the heat transfer section 9, and the wavelength converting section 5. Details concerning the radiation of the heat via the substrate 8, the heat transfer section 9, and the wavelength converting section 5 are explained below.

The heat generated in the light source 3 is radiated to the outside via the substrate 8 and the main body section 2.

However, for example, when electric power input to the light-emitting elements 3b is increased in order to attain a further increase in luminous flux of the luminaire 1, it is likely that a sufficient cooling effect cannot be obtained by only thermal radiation from the main body section 2 side.

If the light-emitting elements 3b are used, a luminous intensity distribution angle is narrow compared with an incandescent lamp. In this case, the luminous intensity distribution angle can be expanded if the shape of the wavelength converting section 5 is set close to the full spherical shape. However, as explained below, if the shape of the wavelength converting section 5 is set close to the full spherical shape, the size of the main body section 2 decreases. Therefore, it is likely that a sufficient cooling effect cannot be obtained by only thermal radiation from the main body section 2 side.

FIGS. 3A and 3B are schematic diagrams for illustrating a relation between the shape of the wavelength converting section and the luminous intensity distribution angle.

FIG. 3A is a schematic diagram for illustrating the relation in the case in which the shape of a wavelength converting section 15 is a semispherical shape and FIG. 3B is a schematic diagram for illustrating the relation in the case in which the shape of a wavelength converting section 25 is close to a full spherical shape.

Arrows in the figures represent an example of traveling directions of light. In this case, to avoid complexity, arrows necessary for explanation of the luminous intensity distribution angle are representatively shown.

When replacement of the existing incandescent lamp is taken into account, it is preferable that the external dimension of the luminaire 1 is the same as the external dimension of the incandescent lamp as much as possible. Therefore, in FIGS. 3A and 3B, the diameter dimension of the wavelength converting sections 15 and 25 is represented as D and the height dimension of the luminaire is represented as H. The diameter dimension D and the height dimension H are set substantially the same as the dimensions of corresponding sections of the incandescent lamp.

As shown in FIG. 3B, if the shape of the wavelength converting section 25 is set close to the full spherical shape, the wavelength converting section 25 can irradiate light to further backward than the wavelength converting section 15 having the semispherical shape shown in FIG. 3A. Therefore, the luminous intensity distribution angle can be expanded.

However, if the shape of the wavelength converting section 25 is set close to the full spherical shape, a height dimension H1b of the wavelength converting section 25 is larger than a height dimension H1a of the wavelength converting section 15. On the other hand, since the height dimension H of the luminaire is fixed, a height dimension H2b of a main body section 22 is smaller than a height dimension H2a of a main body section 12. That is, if the shape of the wavelength converting section 5 is set close to the full spherical shape in order to expand the luminous intensity distribution angle, the size of the main body section 2 decreases and thermal radiation from the main body section 2 side is likely to be difficult.

In this way, when it is attempted to improve basic performance of the luminaire such as an increase in luminous flux and expansion of the luminous intensity distribution angle, it is likely that a sufficient cooling effect cannot be obtained by only thermal radiation from the main body section 2 side.

In this embodiment, since the heat transfer section 9 and the wavelength converting section 5 are provided, it is possible to enjoy effects explained below.

As in the past, heat generated in the light-emitting elements 3b is transferred to the main body section 2 via the substrate 8 and mainly radiated on the side surface of the main body section 2. Heat generated in the wavelength converting section 5 is directly radiated to the outside air. The heat generated in the wavelength converting section 5 is transferred to the heat transfer section 9 and radiated from the heat transfer section 9. The heat generated in the wavelength converting section 5 is transferred to the main body section 2 via the heat transfer section 9 or directly from the other end side and mainly radiated on the side surface of the main body section 2. That is, it is possible to thermally separate the light-emitting elements 3b and the wavelength converting section 5. Therefore, since the heat generated in the wavelength converting section 5 is absent, it is possible to lower the temperature of the light-emitting elements 3b. Since the heat generated in the light-emitting elements 3b is absent, it is possible to lower the temperature of the wavelength converting section 5. Therefore, it is possible to attain extension of the life of the light-emitting elements 3b. Since electric power that can be input to the light-emitting elements 3b can be increased, it is possible to increase a light emission amount. Further, since the temperature of the wavelength converting section 5 can be lowered, it is possible to improve wavelength conversion efficiency.

A joining section 80 including a material having high heat conductivity can be provided between at least a part of end portions 9b and 9c of the heat transfer section 9 and thermal radiation surfaces of the end portions.

For example, the joining section 80 can be provided by joining the end portion 2a of the main body section 2 and the end portion 9b using solder or the like. For example, the joining section 80 can be provided by joining the substrate 8 and the end portion 9c using solder or the like.

The joining section 80 including the material having high heat conductivity can be provided between the wavelength converting section 5 and a peripheral edge portion 9a.

The joining section 80 can be provided by joining the wavelength converting section 5 and the peripheral edge portion 9a using, for example, a high-heat conductivity adhesive added with a ceramics filler, a metal filler, or the like having high heat conductivity.

In order to thermally join the peripheral edge portion or the end portion of the heat transfer section 9 and the opposite side, the peripheral edge portion or the end portion and the opposite side only have to be simply set in contact with each other. However, if the peripheral edge portion or the end portion of the heat transfer section 9 and the opposite side are joined via the joining section 80 including the material having high heat conductivity, it is possible to reduce thermal resistance. Therefore, it is possible to improve a cooling effect explained below.

When the end portion of the heat transfer section 9 and the opposite side are joined, a gap is sometimes formed. If the gap is formed, thermal resistance increases. Therefore, if the end portion of the heat transfer section 9 and the opposite side are joined via the joining section 80 even when the gap is formed, it is possible to reduce the thermal resistance.

The heat transfer section 9 can be formed of a material having high heat conductivity. The heat transfer section 9 can be formed of, for example, metal such as aluminum (Al), copper (Cu), or an alloy of aluminum and copper. However, the material of the heat transfer section 9 is not limited to these materials. The heat transfer section 9 can also be formed of an inorganic material such as aluminum nitride (AlN), an organic material such as high-heat conductive resin, or the like.

A step can be provided at an end portion of the heat transfer section 9 on the wavelength converting section 5 side.

A gap due to a manufacturing error or the like is sometimes formed between the heat transfer section 9 and the wavelength converting section 5. When the gap is formed between the heat transfer section 9 and the wavelength converting section 5, it is likely that lights irradiated from the light-emitting elements 3b leak from the gap or dust present outside intrudes into the inner side of the wavelength converting section 5 from the gap.

Therefore, the step is provided at the end portion of the heat transfer section 9 on the wavelength converting section 5 side.

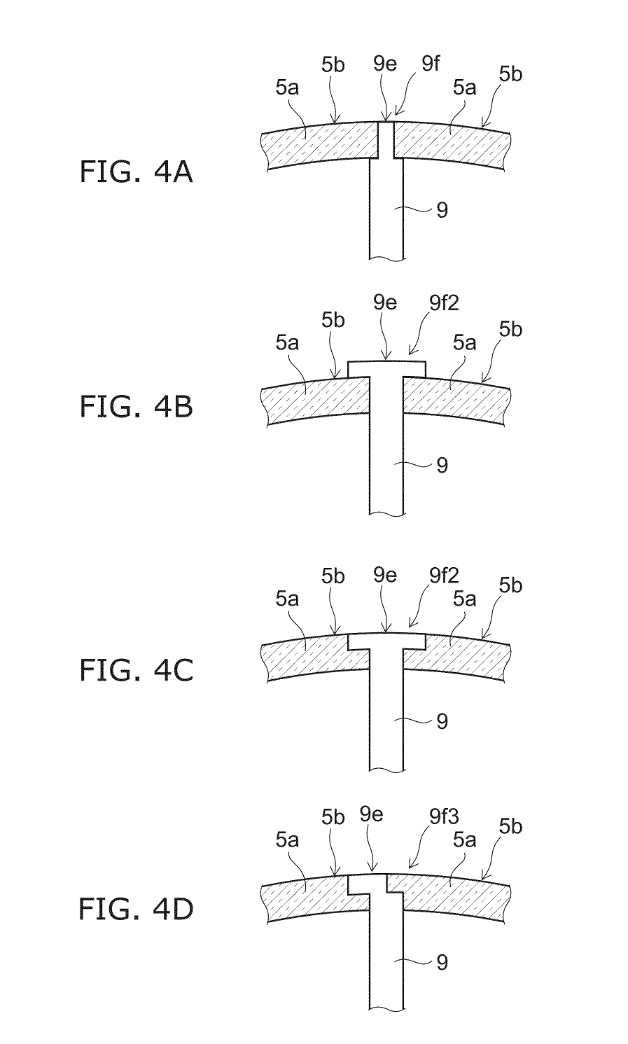

FIGS. 4A to 4D are schematic partially enlarged views for illustrating a step section 9f provided in the step of the heat transfer section 9.

For example, as shown in FIG. 4A, the step section 9f can be a section having a concave form recessed in the thickness direction of the heat transfer section 9 (the thickness direction of the tabular body). If the step section 9f has the concave form, it is possible to superimpose the heat transfer section 9 and the wavelength converting section 5 in a concave portion.

Therefore, it is possible to suppress the lights irradiated from the light-emitting elements 3b from leaking from the gap and suppress dust present outside from intruding into the inner side of the wavelength converting section 5 from the gap. Further, it is also possible to make it easy to assemble the wavelength converting section 5. In this case, it is preferable to set the end face 9e of the heat transfer section 9 and an outer peripheral surface 5b of the wavelength converting section 5 to be flush with each other.

For example, as shown in FIGS. 4B and 4C, a step section 9f2 can be a section having a convex form projecting in the thickness direction of the heat transfer section 9 (the thickness direction of the tabular body). If the step section 9f2 has the convex form, it is possible to superimpose the heat transfer section 9 and the wavelength converting section 5 in a convex portion.

Therefore, it is possible to suppress the lights irradiated from the light-emitting elements 3b from leaking from the gap and suppress dust present outside from intruding into the inner side of the wavelength converting section 5 from the gap.

In this case, as shown in FIG. 4C, it is preferable to set the end face 9e of the heat transfer section 9 and the outer peripheral surface 5b of the wavelength converting section 5 to be flush with each other.

For example, as shown in FIG. 4D, a step section 9f3 having a concave form and a convex form can be formed.

That is, the heat transfer section 9 can be a section including, at the end portion on the wavelength converting section 5, a step section having a form of at least one of a convex shape projecting in the thickness direction of the heat transfer section 9 (the thickness direction of the tabular body) and a concave shape recessed in the thickness direction of the heat transfer section 9 (the thickness direction of the tabular body).

If the heat transfer section 9 is simply provided on the inner side of the wavelength converting section 5, for example, the lights irradiated from the light-emitting elements 3b are absorbed by the heat transfer section 9. Therefore, it is likely that a difference between a bright part and a dark part generated in the wavelength converting section 5 increases and variance in brightness in the luminaire 1 increases.

Therefore, the heat transfer section 9 can reflect the lights irradiated from the light-emitting elements 3b.

In this case, for example, the heat transfer section 9 can be a section having reflectance higher than the reflectance of the wavelength converting section 5.

The heat transfer section 9 can be, for example, a section including a reflecting layer 60 on the surface.

The reflecting layer 60 can be, for example, a layer formed by applying white paint. In this case, paint used for the white painting is preferably paint having resistance against the heat generated in the light source 3 and resistance against the lights irradiated from the light-emitting elements 3b. Such paint can be, for example, polyester resin white paint, acrylic resin white paint, epoxy resin white paint, silicone resin white paint, or urethane resin white paint containing at least one kind of a white pigment of titanium oxide (TiO₂), zinc oxide (ZnO), barium sulfate (BaSO₄), or magnesium oxide (MgO) or a combination of two or more kinds of white paint selected out of these kinds of white paint.

In this case, the polyester resin white paint or the silicon resin white paint is more preferable.

However, the reflecting layer 60 is not limited to these kinds of white paint and can be, for example, a layer formed by coating metal such as silver or aluminum having high reflectance according to a plating method, an evaporation method, or a sputtering method or formed by cladding the metal with a base material.

The heat transfer section 9 itself may be formed of a material having high reflectance.

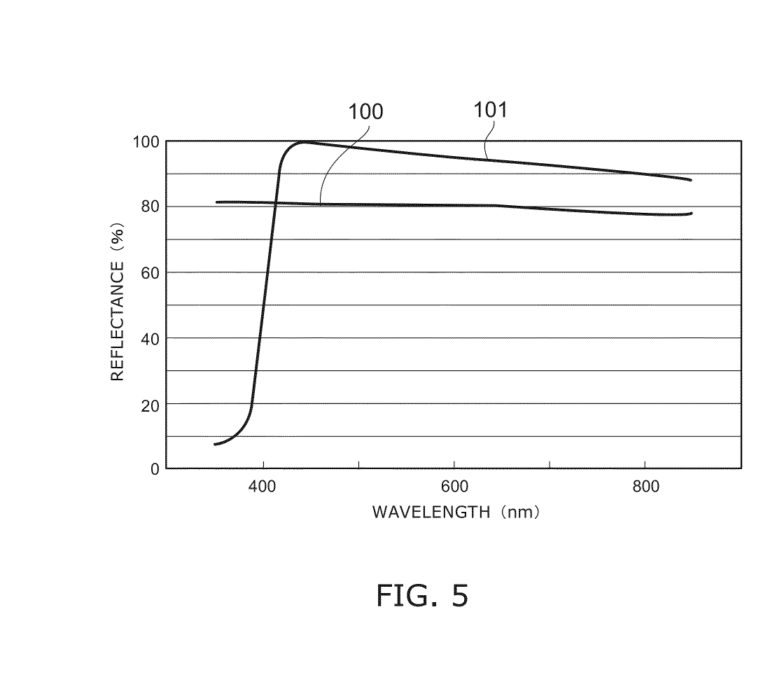

FIG. 5 is a graph for illustrating the reflectance of the reflecting layer.

In FIG. 5, reference numeral 100 denotes a reflecting layer formed of a rolled sheet made of aluminum (A1050 specified in the JIS standard) and 101 denotes a reflecting layer formed by applying the polyester resin white paint.

When the reflecting layer 60 is provided or the heat transfer section 9 itself is formed of a material having high reflectance, it is preferable to set reflectance to lights having a peak wavelength of 430 nm to 500 nm, which are irradiated from the light-emitting elements 3b, to be equal to or higher than 90%. In this case, it is more preferable to set the reflectance to be equal to or higher than 95%.

Therefore, it is more preferable that the reflecting layer 60 is formed by applying the polyester resin white paint.

If the heat transfer section 9 is a section that can reflect the lights irradiated from the light-emitting elements 3b, it is possible to reduce a difference between a bright part and a dark part generated in the wavelength converting section 5. Therefore, it is possible to reduce variance in brightness in the luminaire 1. Further, it is also possible to expand the luminous intensity distribution angle in the luminaire 1.

The heat transfer section 9 has a form in which a tabular body 19a (equivalent to an example of the first tabular body), a tabular body 19b (equivalent to an example of the second tabular body), and a tabular body 19c cross one another on the center axis 1a of the luminaire 1.

The heat transfer section 9 can be a section in which the tabular bodies 19a, 19b, and 19c are arranged to be rotationally-symmetrical with respect to the center axis 1a of the luminaire 1. If a plurality of the light sources 3 are provided in positions substantially rotationally-symmetrical to one another with respect to the center axis 1a of the luminaire 1, the center axis 1a of the luminaire 1 is also an optical axis of the luminaire 1.

In this case, if the three tabular bodies 19a, 19b, and 19c are assembled one by one, it may be difficult to perform proper positioning. Therefore, it is likely that assembly man-hour increases or assembly accuracy is deteriorated.

Therefore, in the example shown in FIG. 1, the tabular unit in which the two tabular bodies are integrally formed is used to make it possible to easily perform proper positioning during assembly.

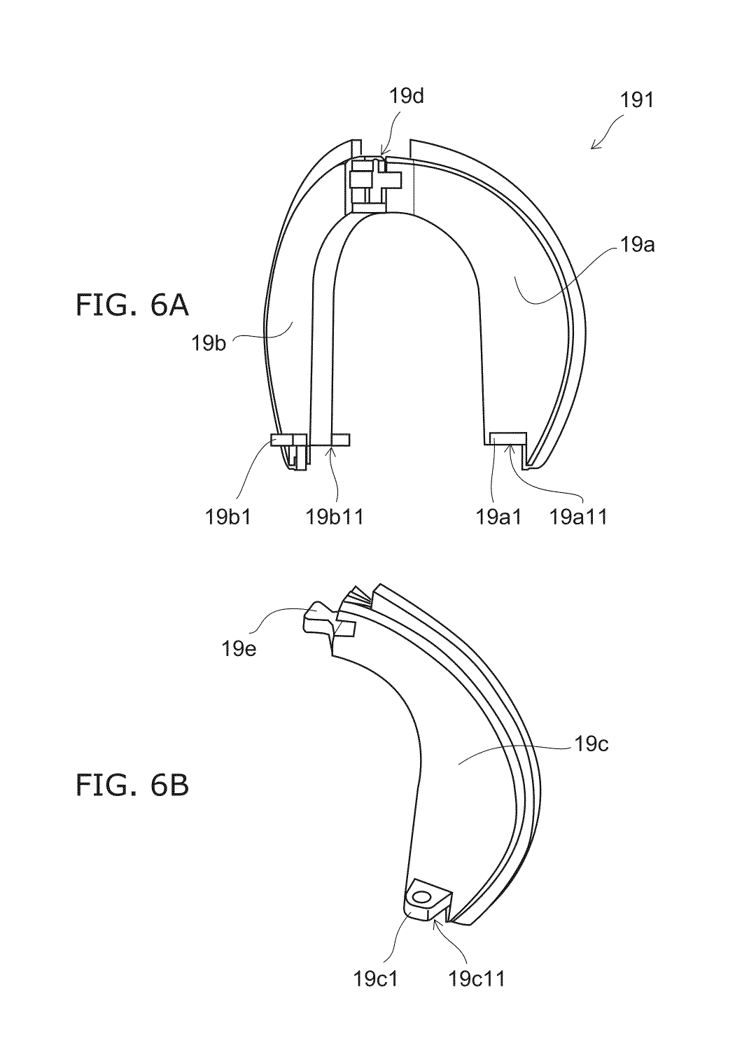

FIGS. 6A and 6B are schematic perspective views for illustrating tabular bodies included in the heat transfer section 9. FIG. 6A is a schematic perspective view for illustrating a tabular unit 191 in which the two tabular bodies 19a and 19b are integrally formed. FIG. 6B is a schematic perspective view for illustrating the tabular body 19c. That is, the heat transfer section 9 includes the tabular unit 191 and the tabular body 19c.

As shown in FIG. 6A, if the tabular unit 191 in which the tabular body 19a and the tabular body 19b crossing the tabular body 19a are integrally formed is adopted, positioning of the tabular body 19a and the tabular body 19b is performed at a stage of components. If the tabular unit 191 is assembled first and the tabular body 19c is assembled with reference to the tabular unit 191, it is possible to easily perform proper positioning of the tabular bodies 19a, 19b, and 19c.

In this case, if the three tabular bodies 19a, 19b, and 19c are integrally formed, it is difficult to place, on the same plane, attaching surfaces 19a11, 19b11, and 19c11 of the attaching sections 19a1, 19b1, and 19c1 respectively provided in the tabular bodies 19a, 19b, and 19c. That is, it is likely that, when the heat transfer section 9 is assembled, backlash occurs or the heat transfer section 9 is assembled in a tilted state.

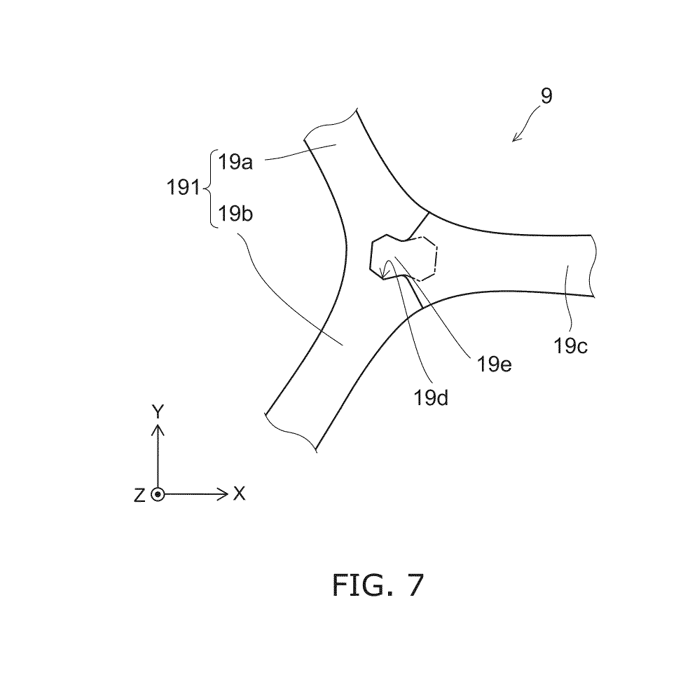

FIG. 7 is a schematic plan view for illustrating connection by a groove section and a protrusion section for connection.

Arrows X, Y, and Z in FIG. 7 represent three directions orthogonal to one another. For example, X and Y represent directions parallel to the end portion 2a of the main body section 2 and Z represents a direction perpendicular to the end portion 2a of the main body section 2.

As shown in FIG. 7, the tabular unit 191 is assembled first and the tabular body 19c is assembled from the Z direction to fit a protrusion section 19e in a groove section 19d. Since the protrusion section 19e is fit in the groove section 19d, it is possible to easily perform proper positioning of the tabular body 19c in the Z direction and the Y direction. Since the tabular body 19c is assembled from the Z direction, it is possible to suppress a gap from being formed between the tabular body 19c and the thermal radiation surface on the side of the end portion 2a of the main body section 2. Therefore, it is possible to suppress thermal resistance between the heat transfer section 9 and the thermal radiation surface on the side of the end portion 2a of the main body section 2 from increasing.

In the above explanation, the heat transfer section 9 is configured by the three tabular bodies. However, the same applies when the heat transfer section 9 is configured by two tabular bodies or four or more tabular bodies. For example, when the heat transfer section 9 is configured by four tabular bodies, it is sufficient that the tabular unit 191 in which two tabular bodies are integrally formed is assembled first and the remaining tabular bodies are assembled to the tabular unit 191 one by one. Further, it is also possible that one tabular unit 191 is assembled first and other tabular units 191 are assembled to the tabular unit 191.

It is also possible that a protrusion section 19e′ is provided in the tabular unit 191 and a groove section 19d′ is provided in the tabular body 19c.

As illustrated in FIG. 1, an opening section 9g is provided in the heat transfer section 9.

As in the example shown in FIG. 1, when the light source 3 is provide at the end portion 2a of the main body section 2, the heat transfer section 9 is provided in a position where the heat transfer section 9 blocks the lights irradiated from the light-emitting elements 3b.

Therefore, since the lights irradiated from the light-emitting section 3b are blocked by the heat transfer section 9, it is likely that light extraction effect is deteriorated.

In this embodiment, the opening section 9g is provided in the heat transfer section 9 to suppress the light irradiated from the light-emitting element 3b from being blocked.

That is, the tabular bodies configuring the heat transfer section 9 respectively include the opening sections 9g that pierce through the tabular bodies in the thickness direction thereof.

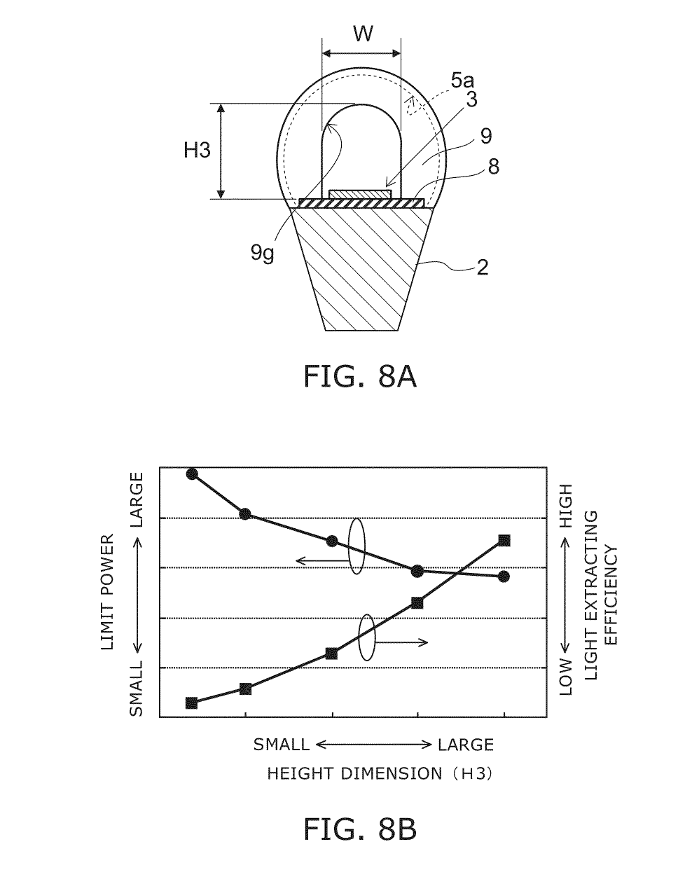

FIGS. 8A and 8B are schematic diagrams for illustrating the opening section 9g provided in the heat transfer section 9.

FIG. 8A is a schematic diagram for illustrating the opening section 9g provided in the heat transfer section 9 and FIG. 8B is a schematic graph for illustrating an effect of providing the opening section 9g.

As shown in FIG. 8A, the opening section 9g having a height dimension H3 is provided in the heat transfer section 9. As explained above, if the opening section 9g is provided, it is possible to suppress the lights irradiated from the light-emitting elements 3b from being blocked.

For example, as shown in FIG. 8B, if the height dimension H3 of the opening section 9g is increased, it is possible to improve light extracting efficiency. In the example shown in FIG. 8B, the height dimension H3 of the opening section 9g is changed. However, the same applies when a width dimension W of the opening section 9g is changed. That is, if the width dimension W of the opening section 9g is increased, it is also possible to improve the light extracting efficiency.

However, if the opening section 9g is extremely large, a heat transfer amount and a thermal radiation amount by the heat transfer section 9 decrease. Therefore, it is likely that electric power that can be input to the light-emitting elements 3b decreases and an amount of lights irradiated from the light-emitting elements 3b decreases.

For example, as shown in FIG. 8B, if the height dimension H3 of the opening section 9g is increased, since the thermal radiation amount by the heat transfer section 9 decreases, limit power (the power that can be input to the light-emitting elements 3b) decreases. If the limit power decreases, an amount of the lights irradiated from the light-emitting elements 3b decreases.

Therefore, it is possible to determine the size of the opening section 9g as appropriate taking into account characteristics of the light-emitting element 3b, improvement of the light extracting efficiency through the provision of the opening section 9g, and deterioration in thermal radiation properties due to the provision of the opening section 9g.

In FIG. 8A, the opening section 9g opened at the peripheral edge of the heat transfer section 9 on the main body section 2 side is illustrated. However, the shape of the opening section 9g and the position where the opening section 9g is provided can be changed as appropriate.

However, if the opening section 9g is provided in a position closer to the light source 3, it is possible to improve the light extracting efficiency. Therefore, as illustrated in FIG. 8A, the opening section 9g opened at the peripheral edge of the heat transfer section 9 on the main body section 2 side is preferable.

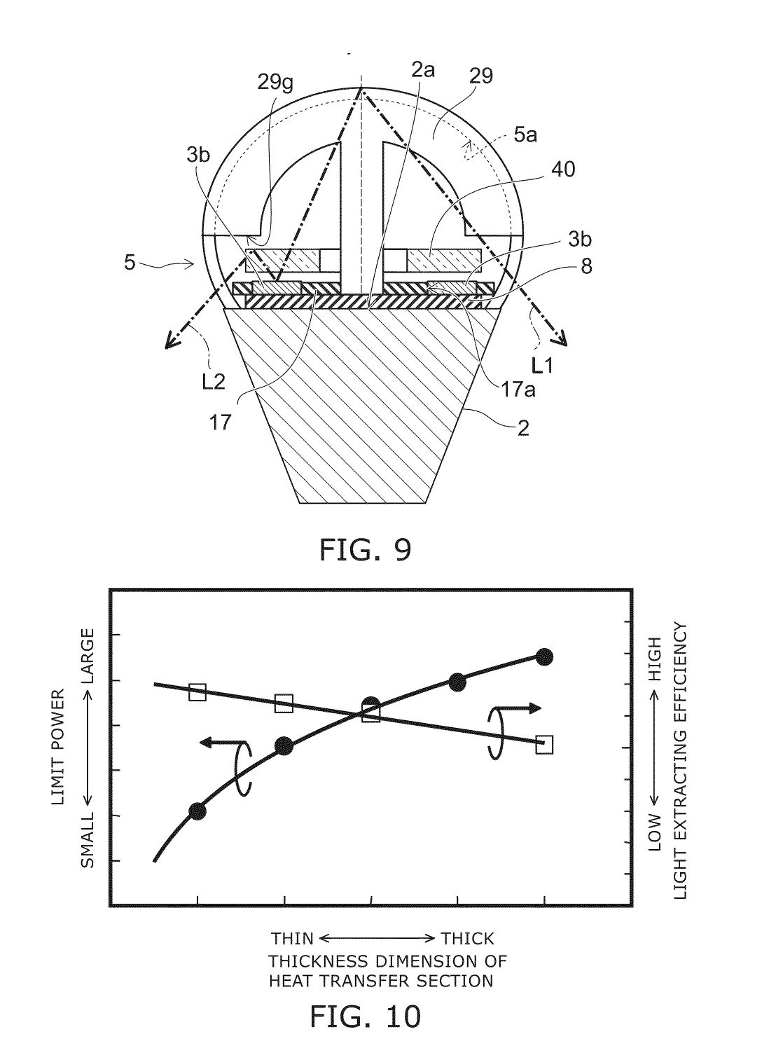

FIG. 9 is a schematic partial sectional view for illustrating an opening section according to another embodiment.

As shown in FIG. 9, an opening section 29g provided in a heat transfer section 29 is opened at an end portion of the heat transfer section 29 on the main body section 2 side and an end on the wavelength converting section 5 side. The heat transfer section 29 is in contact with the substrate 8 and extends to the wavelength converting section 5 side (the upper side) on the center side and extends along the shape of the wavelength converting section 5 near the wavelength converting section 5. The shape of a cross section of the heat transfer section 29 including the axis of the luminaire is an “umbrella shape”.

A state in which a part of the lights irradiated from the light-emitting elements 3b is propagated on the inner side of the wavelength converting section 5 and reflected is projected on the cross section shown in FIG. 9 and indicated by an alternate long and short dash line (lights L1 and L2).

In this case, if the opening section 29g is opened at the peripheral edge of the heat transfer section 29 on the wavelength converting section 5 side, as shown in FIG. 9, the light L1 emitted from the light-emitting elements 3b and reflected on the inner surface of the wavelength converting section 5 and the light L2 reflected on the end face of a lens 40 are irradiated in the back direction of the luminaire. Therefore, it is possible to improve the light extracting efficiency and expands the luminous intensity distribution angle.

In the heat transfer section 29, a tabular body on the left half and a tabular body on the right half in FIG. 9 are integrally formed. The two tabular bodies are joined in, for example, a position indicated by a dotted line portion shown in FIG. 9.

Alternatively, in the heat transfer section 29, the tabular body on the left half and the tabular body on the right half in FIG. 9 may be configured as separate bodies and connected in the dotted line portion shown in FIG. 9.

In the heat transfer section 29, a separate tabular body (not shown in the figure) may be further added. The added tabular body crosses or is connected to the other tabular bodies in the dotted line portion in FIG. 9 and configures a part of the heat transfer section 29.

The light-emitting elements 3b can be arranged in a circular shape. The light-emitting elements 3b can be provided near the wavelength converting section 5.

As shown in FIG. 9, it is easy to provide optical elements such as the lens 40 having an annular shape.

In this case, a position where the opening section 29g is opened at the peripheral edge of the heat transfer section 29 on the wavelength converting section 5 side is not specifically limited.

However, as shown in FIG. 9, if the opening section 29g is opened in a position closer to the main body section 2, it is possible to further improve the light extracting efficiency and further expand the luminous intensity distribution angle.

As illustrated above, the opening section can be opened at least at one of the peripheral edge of the heat transfer section on the main body side and the peripheral edge of the heat transfer section on the wavelength converting section 5 side.

In the case of the example shown in FIG. 1, the plurality of light-emitting elements 3b are gathered and provided in the center portion of the end portion 2a of the main body section 2. On the other hand, in the example shown in FIG. 9, the plurality of light-emitting elements 3b are dispersed and provided near the peripheral edge of the end portion 2a of the main body section 2. In this case, the plurality of light-emitting elements 3b can be arranged on the circumference such that distances from the position of the center axis 1a of the luminaire 1 to the light-emitting elements 3b are equal.

In a reflecting section 17, a plurality of holes 17a that pierce through the reflecting section 17 in the thickness direction are provided. When the light-emitting elements 3b are put in the holes 17a, the upper surfaces (irradiation surfaces) of the light-emitting elements 3b project from the upper surface of the reflecting section 17.

If the light-emitting elements 3b are provided near the peripheral edge of the end portion 2a of the main body section 2, it is possible to expand the luminous intensity distribution angle.

FIG. 10 is a schematic graph for illustrating the thickness dimension of the tabular body.

As shown in FIG. 10, if the thickness dimension of the tabular body is increased, the light extracting efficiency is deteriorated. On the other hand, if the thickness dimension of the tabular body is increased, since the thermal radiation amount by the heat transfer section 9 increases, the limit power increases. If the limit power increases, it is possible to increase an amount of the lights irradiated from the light-emitting elements 3b.

As explained above, when replacement of the existing incandescent lamp is taken into account, it is preferable that the external dimension of the luminaire 1 is the same as the external shape of the incandescent lamp as much as possible. Therefore, since the breadth of a region where the light source 3 and the heat transfer section 9 are arranged is limited, when the thickness dimension of the tabular body is excessively increased, it is likely that the number of the light-emitting elements 3b decreases. When the thickness dimension of the tabular body is excessively increased, it is likely that the light extracting efficiency is deteriorated.

When the thickness dimension of the tabular body is excessively reduced, it is likely that manufacturing of the heat transfer section 9 is difficult.

Therefore, it is preferable that the thickness dimension of the tabular body is set to a thickness dimension determined taking into account the thermal radiation amount by the heat transfer section 9, the breadth of the region where the light source 3 and the heat transfer section 9 are arranged, and the manufacturability of the heat transfer section 9.

According to the knowledge obtained by the inventors, if the thickness dimension of the tabular body is set to be equal to or larger than 0.5 mm and equal to or smaller than 5 mm, all of the thermal radiation amount by the heat transfer section 9, the breadth of the region where the light source 3 and the heat transfer section 9 are arranged, and the nnanufacturability of the heat transfer section 9 can be taken into account. If the thickness dimension of the tabular body is set to be equal to or larger than 0.5 mm and equal to or smaller than 5 mm, it is possible to set the light extracting efficiency to be equal to or higher than 90%.

In order to increase the heat transfer amount and the thermal radiation amount in the heat transfer section 9, the thermal resistance in a connecting portion of the heat transfer section 9 and a component provided on the main body section 2 side only has to be reduced.

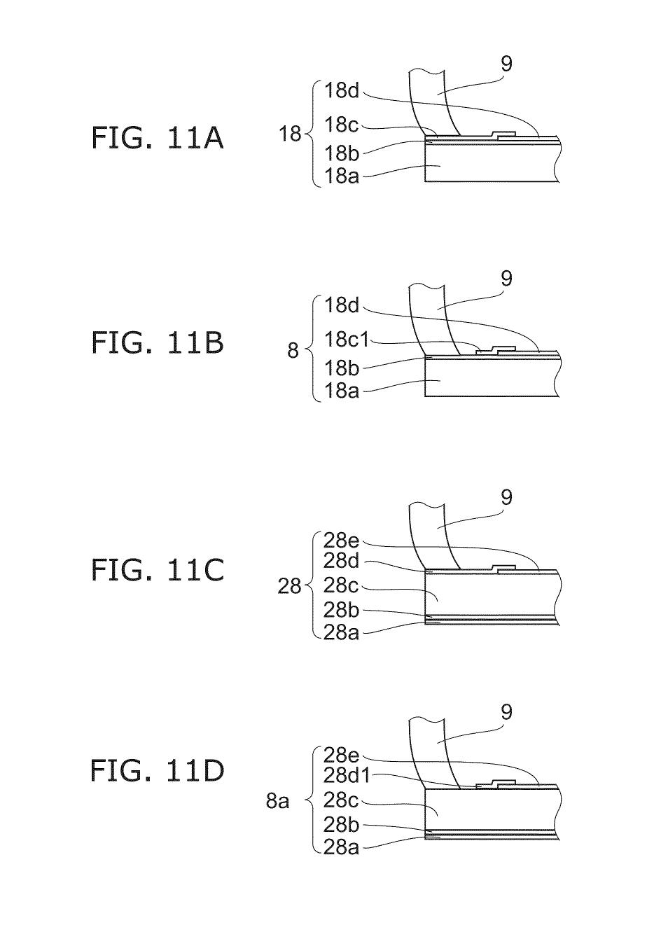

FIGS. 11A to 11D are schematic diagrams for illustrating a connecting portion of the heat transfer section and a substrate. FIGS. 11A and 11C are schematic diagrams in which a decrease in thermal resistance is not taken into account and FIGS. 11B and 11D are schematic diagrams in which a reduction in thermal resistance is attempted.

As shown in FIG. 11A, a substrate 18 includes a base section 18a formed of aluminum, copper, or the like, an insulating section 18b provided on the base section 18a, a solder resist section 18c provided on the insulating section 18b, and a wiring section 18d provided on the insulating section 18b. That is, the substrate 18 is a so-called metal base substrate.

The solder resist section 18c can be formed by applying a solder resist formed of resin or the like using a printing method, a photographic method, or the like.

However, since the solder resist section 18c is formed using the solder resist formed of resin or the like, the thermal resistance in the connecting portion of the heat transfer section 9 and the substrate 18 is high.

On the other hand, as shown in FIG. 11B, the substrate 8 includes the base section 18a, the insulating section 18b provided on the base section 18a, a solder resist section 18c1 provided on the insulating section 18b, and the wiring section 18d provided on the insulating section 18b.

In this case, the solder resist section 18c1 is not provided in a connecting portion of the heat transfer section 9 and the substrate 8. The heat transfer section 9 and the insulating section 18b are connected. Therefore, the thermal resistance can be reduced by the heat resistance of the solder resist section 18c1.

In formation of the solder resist section 18c1, the solder resist section 18c1 can be formed avoiding a region to which the heat transfer section 9 is connected or the solder resist section 18c1 can be formed by peeling the solder resist in the region to which the heat transfer section 9 is connected.

As shown in FIG. 11C, a substrate 28 includes a solder resist section 28a, a wiring section 28b provided on the solder resist section 28a, an insulating section 28c provided on the wiring section 28b, a solder resist section 28d provided on the insulating section 28c, and a wiring section 28e provided on the insulating section 28c. That is, the substrate 28 is a so-called resin substrate.

The solder resist section 28d can be formed by applying a solder resist formed of resin or the like using a printing method, a photographic method, or the like.

However, since the solder resist section 28d is formed using the solder resist formed of resin or the like, the thermal resistance in a connecting portion of the heat transfer section 9 and the substrate 28 is high.

On the other hand, as shown in FIG. 11D, a substrate 8a includes the solder resist section 28a, the wiring section 28b provided on the solder resist section 28a, the insulating section 28c provided on the wiring section 28b, a solder resist section 28d1 provided on the insulating section 28c, and the wiring section 28e provided on the insulating section 28c.

In this case, the solder resist section 28d1 is not provided in a connecting portion of the heat transfer section 9 and the substrate 8a. The heat transfer section 9 and the insulating section 28c are connected. Therefore, it is possible to reduce the thermal resistance by the thermal resistance of the solder resist section 28d1.

In formation of the solder resist section 28d1, the solder resist section 28d1 can be formed avoiding a region to which the heat transfer section 9 is connected or the solder resist section 28d1 can be formed by peeling the solder resist in the region to which the heat transfer section 9 is connected.

That is, the solder resist section formed of the solder resist can be provided avoiding a section between the end portion 9c of the heat transfer section 9 and the substrate 8.

In the above explanation, a member having high thermal resistance is not provided between the end portion 9c of the heat transfer section 9 and the substrate 8. However, a reduction in thermal resistance is not limited to this.

For example, a reduction in thermal resistance can also be attained by increasing a contact area by providing the attaching sections 19a1, 19b1, and 19c1, closely attaching the attaching sections 19a1, 19b1, and 19c1 and the main body section 2 side by, for example, screwing the same, and providing metal having low thermal resistance between the attaching sections 19a1, 19b1, and 19c1 and the main body section 2 side as shown in FIG. 1.

In an example explained below, a diffusing section is provided on the surface of the heat transfer section 9.

The diffusing section is provided to diffuse light made incident on the heat transfer section.

The diffusing section can be, for example, at least one of a protrusion section provided on the surface of the heat transfer section and a diffusion layer 70 (see FIG. 1) including a diffusing agent provided on the surface of the heat transfer section.

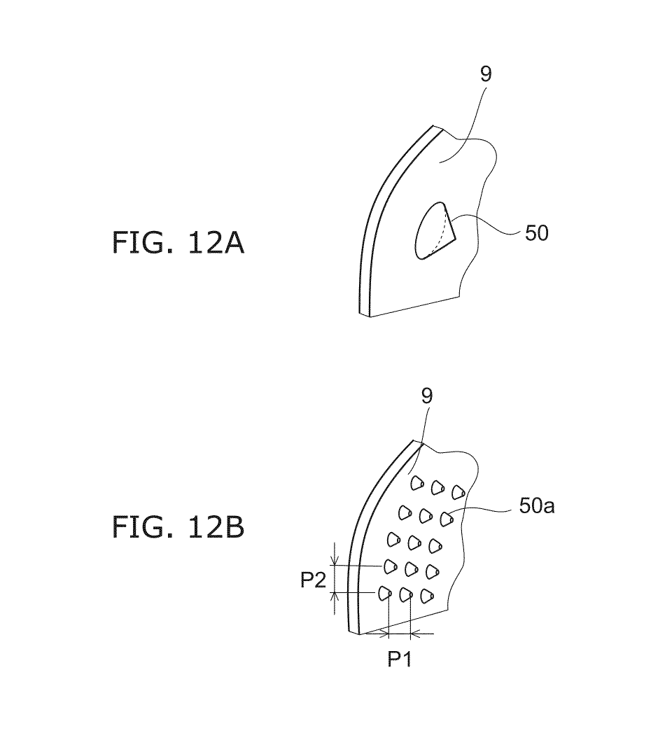

FIGS. 12A and 12B are schematic diagrams for illustrating the protrusion section provided on the surface of the heat transfer section 9.

FIG. 12A is a schematic diagram for illustrating one protrusion section provided on the surface of the heat transfer section 9 and FIG. 12B is a schematic diagram for illustrating a plurality of protrusion sections provided on the surface of the heat transfer section 9.

If the protrusion section is provided on the surface of the heat transfer section 9, light made incident on the heat transfer section 9 can be diffused. If the light made incident on the heat transfer section 9 can be diffused, it is possible to expand the luminous intensity distribution angle.

In this case, one protrusion section 50 can be provided on the surface of the heat transfer section 9 as shown in FIG. 12A or a plurality of protrusion sections 50a can be provided on the surface of the heat transfer section 9 as shown in FIG. 12B.

When the plurality of protrusion sections 50a are provided on the surface of the heat transfer section 9, a regular arrangement form can be adopted or an arbitrary arrangement form can be adopted.

When the plurality of protrusion sections 50a are provided on the surface of the heat transfer section 9, in order to prevent interference fringes from occurring, it is preferable to set pitch dimensions P1 and P2 of the protrusion sections 50a to be equal to or larger than ten times the wavelength of the lights irradiated from the light-emitting elements 3b.

The shape of the protrusion section is not limited to the shape shown in the figure.

In the above explanation, the light made incident on the heat transfer section 9 is diffused by providing the protrusion section on the surface of the heat transfer section 9. However, the light made incident on the heat transfer section 9 can also be diffused by providing the diffusion layer 70 on the surface of the heat transfer section 9.

The diffusion layer 70 can be, for example, a resin layer including a diffusing agent that diffuses light. Examples of the diffusing agent include particulates formed of metal oxide such as silicon oxide or titanium oxide and particulate polymer.

If the diffusion layer 70 is provided on the surface of the heat transfer section 9, light made incident on the heat transfer section 9 can be diffused. If the light made incident on the heat transfer section 9 can be diffused, it is possible to expand the luminous intensity distribution angle.

In FIGS. 12A and 12B, only one surface of the heat transfer section 9 is shown. However, the protrusion section and the diffusion layer can also be provided on the other surface of the heat transfer section 9.

An arrangement of the heat transfer section 9 and the light-emitting element 3b viewed from above the luminaire 1, that is, an arrangement of the heat transfer section 9 and the light-emitting element 3b in plan view is illustrated.

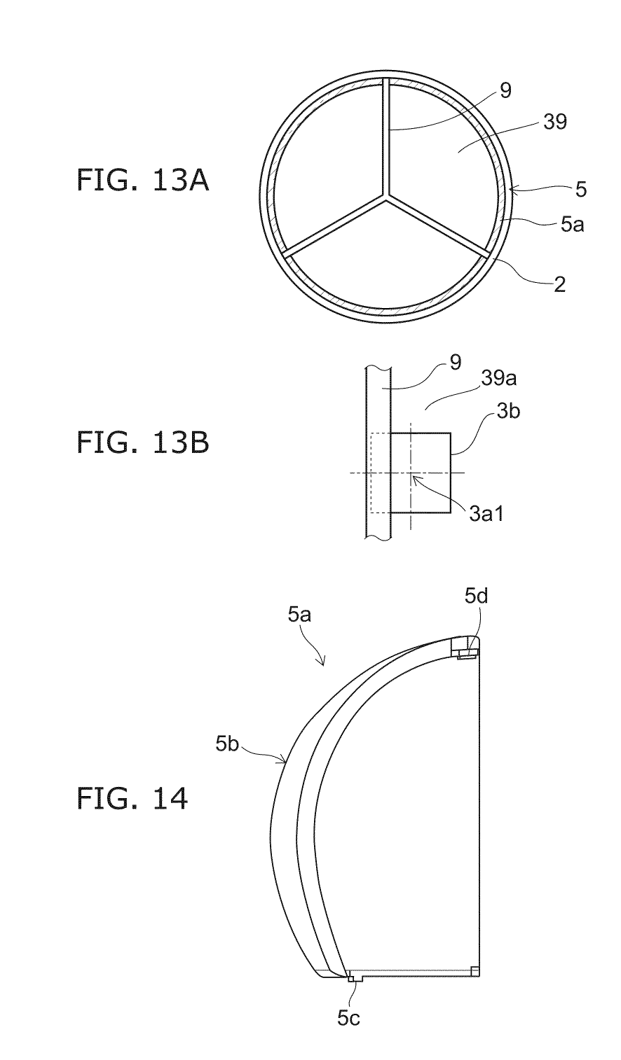

FIGS. 13A and 13B are schematic diagrams for illustrating the arrangement of the heat transfer section 9 and the light-emitting element 3b in plan view.

FIG. 13A is a schematic diagram for illustrating the arrangement of the heat transfer section 9 and the light-emitting element 3b in plan view and FIG. 13B is a schematic diagram for illustrating a positional relation between the heat transfer section 9 and the light-emitting element 3b in plan view.

As shown in FIG. 13A, if the heat transfer section 9 is provided, regions 39 partitioned by the heat transfer section 9 in plan view are formed.

When the plurality of light-emitting elements 3b are provided, in order to suppress variance in luminous intensity distribution and variance in brightness, it is preferable that the numbers of the light-emitting elements 3b provided in the respective regions 39 are the same. In this case, it is preferable to prevent the heat transfer section 9 and the light-emitting elements 3b from overlapping in plan view.

However, according to the knowledge obtained by the inventors, even if there is the light-emitting element 3b overlapping a part of the heat transfer section 9 in plan view, it is possible to suppress variance in luminous intensity distribution and variance in brightness if the heat transfer section 9 and a center 3a1 of the light-emitting element 3b are prevented from overlapping.

In this case, the numbers of the light-emitting elements 3b having the centers 3a1 in the respective regions 39 partitioned by the heat transfer section 9 in plan view only have to be the same.

For example, in FIG. 13B, the light-emitting element 3b is a light-emitting element provided in a region 39a.

It is preferable that the heat transfer section 9 has a form rotationally-symmetrical with respect to the optical axis of the luminaire 1 and the center axis 1a of the luminaire 1. However, if the numbers of the light-emitting elements 3b having the centers 3a1 in the respective regions 39 partitioned by the heat transfer section 9 in plan view are the same, the heat transfer section does not have to have the rotationally-symmetrical form.

The position where the light-emitting elements 3b are provided is not specifically limited. For example, the light-emitting elements 3b can be provided on the center side of the end portion 2a of the main body section 2, can be provided on the peripheral edge side of the end portion 2a of the main body section 2, or can be provided in the entire region of the end portion 2a of the main body section 2.

The wavelength converting section 5 is further illustrated.

As shown in FIG. 1, the wavelength converting section 5 is divided in a portion where the end face 9e of the heat transfer section 9 is exposed from the wavelength converting section 5.

FIG. 14 is a schematic perspective view for illustrating a wavelength converting section 5a divided for each of regions (equivalent to an example of the first or second region) partitioned by the heat transfer section 9.

As shown in FIG. 14, a protrusion section 5c is provided on the end face of the divided wavelength converting section 5a (equivalent to an example of the first or second wavelength converting section) on the main body section 2 side. The protrusion section 5c is provided in a position corresponding to a concave section 2a1 (see FIG. 1) provided at the peripheral edge of the end portion 2a of the main body section 2. A protrusion section 5d is provided on a side opposed to the side of the divided wavelength converting section 5a where the protrusion section 5c is provided. The protrusion section 5d is provided in a position corresponding to a concave section 9k (see FIG. 1) provided at the top of the heat transfer section 9 (near a connecting portion of the tabular bodies 19a, 19b, and 19c). When the divided wavelength converting section 5a is assembled, the protrusion section 5c is fit in the concave section 2a1 provided at the peripheral edge of the end portion 2a of the main body section 2 and the protrusion section 5d is fit in the concave section 9k provided at the top of the heat transfer section 9. In this way, it is possible to easily perform positioning and fixing in assembling the divided wavelength converting section 5a. When the divided wavelength converting section 5a is assembled, the divided wavelength converting section 5a can be fixed using an adhesive or the like.

Blocking at the top of the heat transfer section 9 is illustrated.

As explained above, the heat transfer section 9 is formed by connecting a plurality of tabular bodies to be crossed. Therefore, a gap is sometimes formed at the top of the heat transfer section 9 where a connecting section is provided. When such a gap is formed, it is likely that the lights irradiated from the light-emitting elements 3b leak from the gap and dust present outside intrudes into the inner side of the wavelength converting section 5 from the gap.

Therefore, a blocking section 49 is provided at the top of the heat transfer section 9.

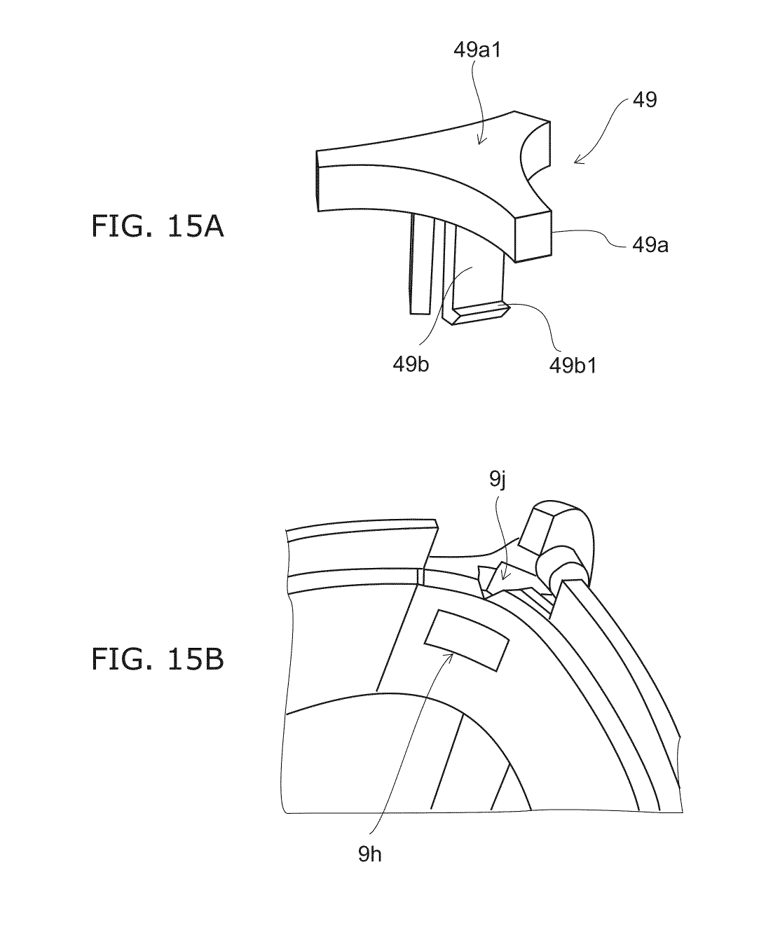

FIGS. 15A and 15B are schematic perspective views for illustrating the blocking section 49.

FIG. 15A is a schematic perspective view for illustrating the blocking section 49 and FIG. 15B is a schematic perspective view for illustrating the top of the heat transfer section 9.

As shown in FIG. 15A, the blocking section 49 includes a blocking body 49a and a connecting section 49b.

The blocking body 49a covers a predetermined region at the top of the heat transfer section 9. The blocking body 49a assumes a tabular shape and has an external shape corresponding to the shape at the top of the heat transfer section 9. The blocking body 49a has a shape in the thickness direction for allowing an outer surface 49a1 of the blocking body 49a and an outer peripheral surface 5a of the wavelength converting section 5 to be smoothly connected when the blocking body 49a is assembled to the heat transfer section 9.

The connecting section 49b is provided to project from the blocking body 49a. A jaw section 49b1 is provided at an end of the connecting section 49b. The jaw section 49b1 is provided in a position corresponding to a hole 9h provided in the heat transfer section 9. The connecting section 49b is formed of an elastic material such as resin and can be bent.

When the blocking section 49 is assembled to the heat transfer section 9, the connecting section 49b is inserted to be fit in a hole 9j provided at the top of the heat transfer section 9 and the jaw section 49b1 is fit in the hole 9h to fix the blocking section 49 to the heat transfer section 9.

If the blocking section 49 is provided at the top of the heat transfer section 9 where the connecting section is provided, it is possible to prevent the wavelength converting section 5 from shifting and press down the wavelength converting section 5. Therefore, it is possible to suppress the lights irradiated from the light-emitting elements 3b from leaking from the gap and prevent dust present outside from intruding into the inner side of the wavelength converting section 5 from the gap.

Actions and effects of the heat transfer section 9 are illustrated.

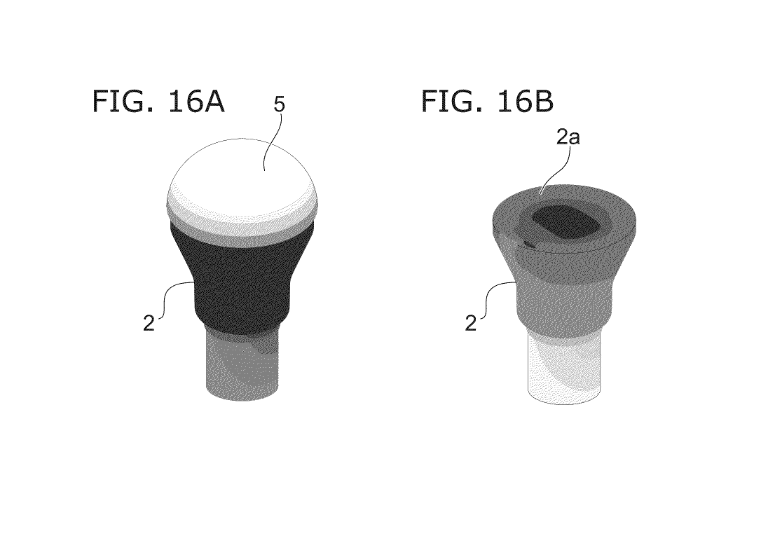

FIGS. 16A and 16B are schematic diagrams for illustrating a state of thermal radiation in a luminaire in which the heat transfer section 9 is not provided.

FIG. 16A is a schematic diagram for illustrating a temperature distribution of the luminaire and FIG. 16B is a schematic diagram for illustrating a temperature distribution near the end portion 2a of the main body section 2.

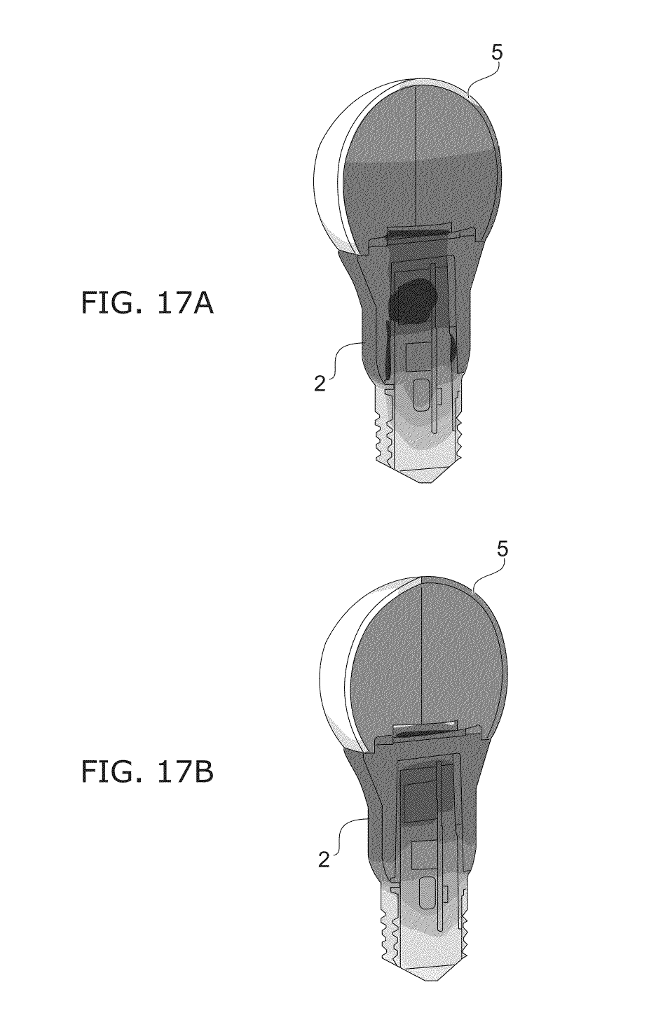

FIGS. 17A and 17B are schematic diagrams for illustrating a state of thermal radiation in a luminaire in which the heat transfer section 9 is provided.

FIG. 17A is a schematic diagram for illustrating the state of thermal radiation in the case in which the inner surface of the wavelength converting section 5 and the end face of the heat transfer section 9 are in contact with each other (the end face of the heat transfer section is not exposed from the wavelength converting section 5) and FIG. 17B is a schematic diagram for illustrating the state of thermal radiation in the case in which the end face of the heat transfer section 9 is exposed from the wavelength converting section 5.

In FIGS. 16A and 16B and 17A and 17B, a temperature distribution of the luminaire is calculated by a simulation. The power of the light source 3 is set to about 5 W (watt) and an environmental temperature is set to about 25° C.

The temperature distribution is represented by gradations of a monotone color. The monotone color is displayed darker as the temperature is higher and is displayed lighter as the temperature is lower.

When the heat transfer section 9 is not provided, as shown in FIG. 16A, the surface temperature of the wavelength converting section 5 is low but the temperature of the main body section 2 is high.

In this case, as shown in FIG. 16B, the temperature near the end portion 2a of the main body section 2 is high.

That is, it is seen that, when the heat transfer section 9 is not provided, heat generated in the light source 3 is radiated from the main body section 2 side and radiation of heat from the wavelength converting section 5 side is little. As shown in FIG. 16B, it is also seen that a sufficient cooling effect cannot be obtained by only thermal radiation from the main body section 2 side.

On the other hand, when the heat transfer section 9 is provided, the heat generated in the light source 3 can be transferred to the wavelength converting section 5 side by the heat transfer section 9. Therefore, as shown in FIGS. 17A and 17B, it is possible to lower the temperature of the main body section 2 through thermal radiation from the wavelength converting section 5 side.

Further, if the end face of the heat transfer section 9 is exposed from the wavelength converting section 5, as shown in FIG. 17B, it is possible to further lower the temperature of the main body section 2.

The fall in the temperature of the main body section 2 means that a temperature rise of the light-emitting elements 3b can be suppressed.

According to this embodiment, since heat can be radiated from the wavelength converting section 5 side as well via the heat transfer section 9, it is possible to attain improvement of the thermal radiation properties of the luminaire 1 and improvement of the light emission efficiency. It is possible to attain the extension of the life of the luminaire 1. Further, it is possible to improve the basic performance of the luminaire 1 such as an increase in luminous flux and expansion of the luminous intensity distribution angle.

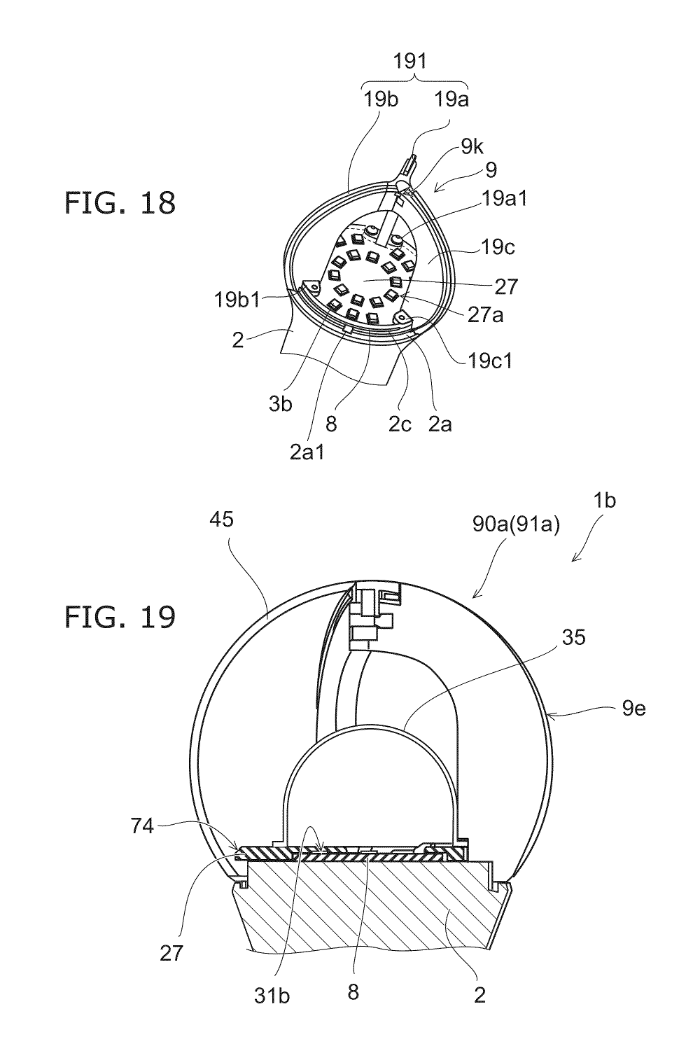

FIG. 18 is a schematic perspective view for illustrating a reflecting section 27 according to another embodiment.

As shown in FIG. 18, the plurality of light-emitting elements 3b are provided to be dispersed near the peripheral edge of the end portion 2a of the main body section 2. The plurality of light-emitting elements 3b can be arranged on the circumference such that distances from the position of the center axis 1a of the luminaire 1 to the light-emitting elements 3b are equal. That is, the plurality of light-emitting elements 3b are arranged on the circumference of a circle centering on the position of the center axis 1a of the luminaire 1. In this case, as shown in FIG. 18, the plurality of light-emitting elements 3b can be arranged on a plurality of concentric circles. In the example shown in FIG. 18, the plurality of light-emitting elements 3b are arranged on two concentric circles. However, the number of concentric circles may be one or may be three or more.

For example, it is suitable that the plurality of light-emitting elements 3b (e.g., sixteen light-emitting elements 3b) are arranged at an equal interval on the circumference 28 mm in diameter centering on the center axis 1a.

The reflecting section 27 can be a tabular body.

The reflecting section 27 is provided on the substrate 8.

A plurality of holes 27a that pierce through the reflecting section 27 in the thickness direction are provided in the reflecting section 27. When the light-emitting elements 3b are put in the holes 27a, the upper surfaces (irradiation surfaces) of the light-emitting elements 3b project from the upper surface of the reflecting section 27.

If the light-emitting elements 3b are provided near the peripheral edge of the end portion 2a of the main body section 2, it is possible to expand the luminous intensity distribution angle. If a convex section (e.g., a convex section having a conical shape, a circular truncated cone shape, a polygonal shape, or a polygonal trapezoidal shape) projecting to one end side is formed in the center portion of the reflecting section 27, it is possible to further expand the luminous intensity distribution angle.

FIG. 19 is a schematic sectional view for illustrating a luminaire 1b according to another embodiment.

As shown in FIG. 19, the luminaire lb includes the main body section 2, the light-emitting elements 3b, a wavelength converting section 35, the reflecting section 27, the substrate 8, a heat transfer section 90a or a heat transfer section 91a, and a globe 45. Although not shown in the figure, the luminaire 1b includes the cap section 6 and the like as well.

The heat transfer section 90a can be the same as the heat transfer section 9 explained above.

The heat transfer section 91a can be same as the heat transfer section 9 explained above.

The globe 45 is provided on the end portion 2a side of the main body section 2 to cover the wavelength converting section 35.

The globe 45 has a form same as the form of the wavelength converting section 5 but does not include a phosphor.

The globe 45 has translucency and enables lights irradiated from the light-emitting elements 3b to be emitted to the outside of the luminaire 1b. The globe 45 can be formed of a translucent material. The globe 45 can be formed of a light diffusive material. The globe 45 can be formed of a resin material such as polycarbonate. The globe 45 may be divided in a portion where the end face 9e of the heat transfer section 9 is exposed from the globe 45 or may be a semispherical globe as long as the globe 45 fits in the opening section 9g.

Consequently, it is possible to easily assemble the luminaire 1b having high thermal radiation properties.

The wavelength converting section 35 is provided on the end portion 2a side of the main body section 2 to cover the plurality of light-emitting elements 3b. That is, the wavelength converting section 35 is provided at the end portion 2a of the main body section 2 to be separated from the light-emitting element 3b. The wavelength converting section 35 can be a section having a curved surface projecting in a light irradiating direction. A leg projecting in the outer end direction is formed on the other end side. The leg is held by one end side of the reflecting section 27 and the other end side of the heat transfer section 9.

The material and the phosphor of the wavelength converting section 35 can be the same as those illustrated in the wavelength converting section 5.

The wavelength converting section 5 illustrated in FIG. 1 functions as a globe as well. On the other hand, the wavelength converting section 35 absorbs a part of the lights irradiated from the light-emitting elements 3b and emits fluorescence having a predetermined wavelength. The wavelength converting section 35 is provided separately from the globe 45.

The wavelength converting section 35 is in contact with the heat transfer section 90a or the heat transfer section 91a. As explained above, the wavelength converting section 35 functions as a heat generation source. Therefore, the wavelength converting section 35 is set in contact with the heat transfer section 90a or the heat transfer section 91a to radiate the heat generated in the wavelength converting section 35.

Therefore, since the heat generated in the wavelength converting section 35 can be efficiently radiated, it is possible to increase electric power input to the light-emitting elements 3b. As a result, it is possible to attain improvement of the light emission efficiency.

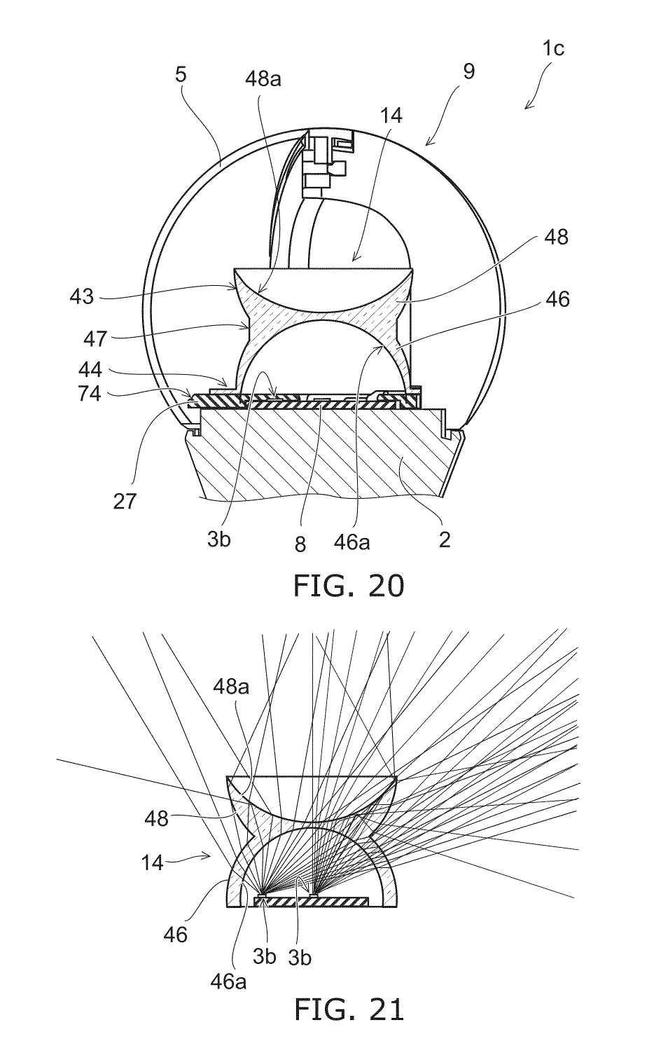

FIG. 20 is a schematic sectional view for illustrating a luminaire 1c according to another embodiment.

As shown in FIG. 20, the luminaire 1c includes the main body section 2, the light-emitting elements 3b, the wavelength converting section 5, the reflecting section 27, the substrate 8, the heat transfer section 9, and a lens 14. Although not shown in the figure, the luminaire 1c includes the cap section 6 and the like as well.

The lens 14 includes a lens main body 43 and an attachment leg 44.

The lens main body 43 controls lights irradiated from the plurality of light-emitting elements 3b. The lens main body 43 is attached to the reflecting section 27 by the attachment leg 44.

The lens 14 can be formed by integral molding using transparent resin such as polycarbonate having a refractive index of 1.45 to 1.6.

The lens main body 43 includes a first lens section 46 having a semispherical shell shape or a spheroidal shape and a second lens section 48 having a semispherical shell shape or a spheroidal shape.

The first lens section 46 includes a first concave section 46a opened on the light-emitting elements 3b side.

The second lens section 48 includes a second concave section 48a opened on a side opposite to the light-emitting elements 3b side.

In the lens main body 43, the first concave section 46a and the second concave section 48a are opposed to each other and integrated.

The attachment leg 44 is provided at an end portion of the first lens section 46 on the light-emitting element 3b side. The attachment leg 44 can be provided to be rotationally symmetrical with respect to the center axis of the lens 14. The attachment leg 44 projects toward the outside of the first lens section 46. The attachment leg 44 is held by the reflecting section 27 and the heat transfer section 9.

The lens main body 43 can be formed of a glass material as well. In this case, the lens main body 43 and the attachment leg 44 may be separately formed and joined.

Actions and effects of the lens 14 are illustrated.

FIG. 21 is a schematic diagram for illustrating actions and effects of the lens 14.

As shown in FIG. 21, lights emitted from the light-emitting elements 3b are transmitted through a space in the first concave section 46a and made incident on the first lens section 46. A part of the lights made incident on the first lens section 46 is refracted on the inner surface of the second concave section 48a and emitted to the outside of the lens 14. A part of the lights made incident on the first lens section 46 is refracted on the outer surface of the second lens section 48 and emitted to the outside of the lens 14. A part of the lights made incident on the first lens section 46 is refracted on the outer surface of the first lens section 46 and emitted to the outside of the lens 14. A part of the lights made incident on the first lens section 46 is totally reflected on the inner surface of the second concave section 48a and emitted to the outside of the lens 14.

FIG. 21 illustrates routes of lights irradiated from the light-emitting element 3b provided in the center portion of a region where the plurality of light-emitting elements 3b are provided.

Lights having small incident angles among lights made incident on the inner surface of the second concave section 48a, the outer surface of the second lens section 48, and the outer surface of the first lens section 46 have small differences between the incident angles and angles of refraction. The lights are emitted mainly in the front direction or the side direction of the lens 14.

On the other hand, lights having large incident angles among the lights made incident on the inner surface of the second concave section 48a have large differences between the incident angles and angles of refraction. The lights are emitted mainly in the side direction or the back direction of the lens 14.

In this way, if the lens 14 is provided, it is possible to expand the luminous intensity distribution angle of the lights irradiated from the light-emitting element 3b provided in the center portion of the region where the plurality of light-emitting elements 3b are provided.

FIG. 21 illustrates routes of lights irradiated from the light-emitting element 3b provided in the peripheral edge portion of the region where the plurality of light-emitting elements 3b are provided.

As shown in FIG. 21, lights having small incident angles among lights made incident on the inner surface of the second concave section 48a, the outer surface of the second lens section 48, and the outer surface of the first lens section 46 have small differences between the incident angles and angles of refraction. The lights are emitted mainly in the front direction or the side direction of the lens 14.

On the other hand, lights having large incident angles among the lights made incident on the inner surface of the second concave section 48a have large differences between the incident angles and angles of refraction. The lights are emitted mainly in the side direction or the back direction of the lens 14.

In this way, if the lens 14 is provided, it is possible to expand the luminous intensity distribution angle of the lights irradiated from the light-emitting element 3b provided in the peripheral edge portion of the region where the plurality of light-emitting elements 3b are provided.

The lights emitted in the side direction and the back direction of the lens 14 is further refracted by the wavelength converting section 5. Therefore, the lights are easily emitted in the side direction and the back direction of the luminaire. Therefore, the lights irradiated from the light-emitting elements 3b can be distributed at a wide angle over the front direction to the back direction of the luminaire by the lens 14 and the wavelength converting section 5.

If the external dimension of the wavelength converting section 5 on the main body section 2 side is longer than the external dimension of the flat surface 21 of the main body section 2, the lights transmitted through the wavelength converting section 5 are more easily emitted in the back direction of the luminaire. Therefore, it is possible to further expand the luminous intensity distribution angle.

The shape of the lens 14 is not limited to the shape illustrated in FIG. 21. The lens 14 only has to have a shape capable of refracting the lights generated by the light source 3 in the side direction and the back direction of the luminaire 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Also each of the embodiments described above may be implemented in combination with one another.

What is claimed is:

1. A luminaire comprising:
a main body section including a flat surface on one end side;
a light-emitting module provided to be thermally joined to the flat surface of the main body section and including a light-emitting element that emits light having a peak wavelength equal to or larger than 430 nm and equal to or smaller than 500 nm;
a reflecting section provided on one end side of the main body section and configured to reflect the light emitted from the light-emitting element;
a heat transfer section provided such that one end side thereof projects to the one end side of the main body section, the other end side of which being connected to the main body section; and
a wavelength converting section provided spaced apart from the light-emitting element to cover the light-emitting module and to be thermally joined to the main body section and the heat transfer section.

2. The luminaire according to claim 1, wherein
the flat surface is provided to be orthogonal to a center axis of the luminaire, and
the reflecting section is a tabular body including at least one opening and is provided on the flat surface to expose the light-emitting element from the opening to the one end side of the main body section.

3. The luminaire according to claim 2, wherein the reflecting section is arranged on the flat surface and includes an inclined surface at an outer end portion, the inclined surface facing one end side.

4. The luminaire according to claim 2, wherein, when a dimension from a position of the center axis of the luminaire to an outer end portion on the one end side of the main body section is represented as R, a dimension from the flat surface of the main body section to a top of the luminaire is represented as L, a dimension from the position of the center axis of the luminaire to an outer end portion of the reflecting section is represented as r, and a dimension from the reflecting section to the top of the luminaire is represented as I, the following expression is satisfied:
r>R·I/L

5. The luminaire according to claim 4, wherein
the wavelength converting section includes, between the reflecting section and the top of the luminaire, a largest diameter section where a dimension from the position of the center axis of the luminaire to an inner surface of the wavelength converting section is larger than the dimension R, and
a dimension of a portion located on the outer end side of the reflecting section from the position of the center axis of the luminaire to the inner surface of the portion is larger than the dimension R and smaller than the largest diameter section.

6. The luminaire according to claim 2, wherein, when a dimension from a position of the center axis of the luminaire to an outer end portion on the one end side of the main body section is represented as R, a dimension from the flat surface of the main body section to a top of the luminaire is represented as L, a dimension from the position of the center axis of the luminaire to an outer end portion of the reflecting section is represented as r, and a dimension from the reflecting section to the top of the luminaire is represented as I, the following expression is satisfied:
r≦R·I/L

7. The luminaire according to claim 6, wherein
the wavelength converting section includes, between the reflecting section and the top of the luminaire, a largest diameter section where a dimension from the position of the center axis of the luminaire to an inner surface of the wavelength converting section is larger than the dimension R, and
a dimension of a portion located on the outer end side of the reflecting section from the position of the center axis of the luminaire to the inner surface of the portion is larger than the dimension R and smaller than the largest diameter section.

8. The luminaire according to claim 1, wherein the wavelength converting section is connected to a surface on the outer end side of the heat transfer section such that at least a part of the heat transfer section is in contact with outside air.

9. The luminaire according to claim 1, wherein
the heat transfer section includes:
a first tabular body provided such that the other end side is connected to an outer end portion of the main body section and the one end side projects toward a top of the luminaire; and
a second tabular body, the other end side of which is connected to the outer end portion of the main body section in a position different from the first tabular body and the one end side of which projects to the one end side of the main body section toward the top of the luminaire, the second tabular body being connected to the first tabular body near the top,
the wavelength converting section includes a first wavelength converting section and a second wavelength converting section, the first wavelength converting section is provided in a first region partitioned by the first tabular body and the second tabular body, and
the second wavelength converting section is provided in a second region partitioned by the first tabular body and the second tabular body.

10. The luminaire according to claim 1, wherein an end face of the heat transfer section is exposed from the wavelength converting section.

11. The luminaire according to claim 1, wherein the wavelength converting section includes a phosphor.

12. The luminaire according to claim 1, wherein the light-emitting module is held by the main body section and the reflecting section.

13. The luminaire according to claim 1, wherein, when an angle formed by the inclined surface of the reflecting section and an axis extending along a center axis of the luminaire is represented as α and an angle formed by an outer end portion on the one end side of the main body section and the axis extending along the center axis of the luminaire is represented as β, the following expression is satisfied:
α≧β

14. The luminaire according to claim 2, wherein a surface on one end side of the light-emitting element projects from a surface on one end side of the reflecting section in a direction of a top of the luminaire.

15. The luminaire according to claim 1, wherein the heat transfer section has reflectance higher than reflectance of the wavelength converting section.

16. The luminaire according to claim 1, wherein the heat transfer section assumes a tabular shape and includes an opening section that pierces through the heat transfer section in a thickness direction.

17. The luminaire according to claim 16, wherein the thickness dimension of the heat transfer section is equal to or larger than 0.5 mm and equal to or smaller than 5 mm.

18. The luminaire according to claim 1, wherein
a plurality of the light-emitting elements are provided, and
the plurality of light-emitting elements are arranged on a circumference of a circle centering on a position of a center axis of the luminaire.

19. The luminaire according to claim 1, further comprising a globe configured to cover the wavelength converting section.

20. The luminaire according to claim 1, further comprising a lens including a first concave section opened on the light-emitting element side and a second concave section opened on a side opposite to the light-emitting element side, the lens being provided between the light-emitting module and the wavelength converting section.
